(19) United States
(12) Patent Application Publication
(10) Pub. No.: US 2015/0058195 A1
(43) Pub. Date: Feb. 26, 2015

(54) SYSTEM AND METHOD FOR MONITORING AN EQUITY RIGHTS TRANSACTION FOR STRATEGIC INVESTORS IN A SECURITIES EXCHANGE

(71) Applicant: Miami International Securities Exchange, LLC, Princeton, NJ (US)

(72) Inventors: Barbara J. COMLY, Lambertville, NJ (US); Thomas P. Gallagher, Belle Mead, NJ (US); Douglas M. Schafer, JR., Rose Valley, PA (US); Shelly Brown, Belle Mead, NJ (US); Randy Foster, Horsham, PA (US)

(73) Assignee: Miami International Securities Exchange, LLC, Princeton, NJ (US)

(21) Appl. No.: 14/465,472

(22) Filed: Aug. 21, 2014

Related U.S. Application Data
(60) Provisional application No. 61/868,396, filed on Aug. 21, 2013.

(51) Int. Cl. G06Q 40/04; G06Q 50/18

(52) U.S. Cl. CPC G06Q 40/04; G06Q 50/18
USPC 705/37

(57) ABSTRACT

A system and method for monitoring an equity rights transaction for strategic investors in a securities exchange. More specifically, a technological infrastructure which monitors an equity rights program in which units representing the right to acquire equity in an exchange or an exchange's parent holding company are issued to a participating member in exchange for a cash payment and the achievement of certain volume thresholds on the exchange over a specified period.

### FIELD OF THE INVENTION

The disclosed embodiments relate to a system and method for monitoring an equity rights transaction for strategic investors in a securities exchange. In particular, the disclosed embodiments relate to a technological infrastructure which monitors an equity rights program in which units representing the right to acquire equity in an exchange or an exchange's parent holding company are issued to a participating member in exchange for a cash payment and the achievement of certain volume thresholds on the exchange over a specified period.

### BACKGROUND OF THE INVENTION

Establishing a new securities exchange requires the design and development of a significant administrative and technological infrastructure. It also entails an extensive regulatory approval process with the Securities and Exchange Commission (SEC). Moreover, the infrastructure and regulatory approvals must be in place before orders are placed in the new exchange, which is typically before revenue has been generated by exchange activity.

Established securities exchanges, such as the New York Stock Exchange (NYSE), American Stock Exchange (AMEX), and the Chicago Board Options Exchange (CBOE) can raise funds through conventional public equity offerings for infrastructure improvement and expansion. Alternatively, an established securities exchange can raise funds from its members, e.g., by making an equity offering to members in the form of stock and/or stock options. Some equity deals of this type have involved both an equity offering to members, i.e., seat-holders of the exchange, and an offering of equity to external investors.

For a relatively new securities exchange, it can be difficult to raise funds in the public equity markets, because it takes time for a new exchange to reach a significant trading volume level and to establish a history of successful operation. Furthermore, legal issues can arise due to regulatory restrictions on the purchase of equities by certain entities, such as, for example, bank holding companies.

### SUMMARY OF THE INVENTION

In one aspect, the disclosed embodiments include a method for monitoring an equity rights program in which units representing the right to acquire equity in an exchange are issued to participating members based upon achievement of defined volume thresholds on the exchange over specified periods. The method is implemented using a server having a processor, memory, and a storage medium. The method includes storing exchange trade data in a trading data storage in a time series format. The trading data storage is implemented in the storage medium of the server. The exchange trade data is received, via a network interface of the server, from a trade data output of the exchange.

The method further includes retrieving the stored exchange trade data from the trading data storage; transforming the exchange trade data into a star schema data format; and storing the transformed exchange trade data in a reporting data storage. The method further includes retrieving, from a clearing entity, industry options trade data and industry options exercise data; transforming the retrieved industry options trade data and the industry options exercise data into a star schema data format; and storing the transformed industry options trade data and the transformed industry options exercise data in the reporting data storage.

The method further includes processing the stored transformed exchange trade data, the stored transformed industry options trade data, the stored transformed industry options exercise data, and reference data. The reference data includes the defined volume thresholds on the exchange over one or more time periods of the specified periods. The processing produces performance data for each of the participating members, the performance data comprising a measure of the achievement of each of the participating members relative to their corresponding defined volume thresholds on the exchange over the one or more time periods.

In another aspect, the exchange platform executes a process that outputs, e.g., on a daily basis, how a participant is performing versus their requirements arising from the strategic equity transaction. This provides participants with real time information on whether the volume they are bringing to the exchange is sufficient to meet the requirements of the particular sub-program or “option” in which they are participating.

Certain embodiment may provide monitoring of trading volume by participants and comparison to the particular requirements for each participant based on the option or options of the equity rights program in which they are participating. This may include providing reports at particular intervals, e.g., daily, weekly, or monthly, or in accordance with a performance measurement periods, e.g., thirty days before the measurement period ends.

In another aspect of the disclosed invention, one or more options are offered to participants in the program, e.g., “Option A,” “Option B,” and “Option C.” Option A allows a participant to purchase an amount of shares, e.g., of common stock, and to receive warrants in exchange for meeting certain order flow requirements. Option B, on the other hand, allows a participant to prepay certain exchange fees and receive warrants, which are, again, dependent on order flow, i.e., order volume provided by the participant. Option B, in a sense, is like getting a rebate in the form of equity to participants who prepay fees and perform at a certain level, i.e., meet certain volume requirements. Among the advantages of Option B is that it allows participants who may face restrictions on equity purchases, such as, for example, a bank holding company, to obtain warrants through the program. Option C is discussed below.

In one aspect of the disclosed embodiments, the exchange is a fully-electronic exchange for the trading of equity options. Members of the securities exchange (i.e., “participants”) are offered the opportunity to participate in any combination of the three equity transactions described herein. Each Participant has the option to participate in any combination of: (a) an offering of up to 10 “A-Units;” (b) an offering of up to 10 “B-Units;” and (c) the “C Warrant” rebate program. A description of the terms and conditions of each offering is set forth below. Participants have the opportunity to acquire A-Units and B-Units separately or in combination with one another. In certain embodiments, all members of the Exchange are eligible to participate in the C Warrant Rebate Program regardless of whether such member acquires A or B Units.

In certain embodiments, under Option C, the participants can come into the equity transaction at one of three different times during the duration of the equity rights program. This provides an opportunity to participate only in particular selected aspects of the performance measurement regimes. Allowing for participants to enter into Option C at different times (e.g., three different times) provides a more fair and “democratic” opportunity to participate actively in a consortium deal or an exchange through the purchase of equity.

In certain embodiments, there may be a “look back” or “catch up” provision so that if participant does not achieve the required volume minimums in a given period, then the participant may be able to rely on over-performance in a preceding or succeeding period.

In certain embodiments, the pre-paid fees may be placed in an escrow account so that the participant is not a creditor of the exchange until such time as it actually used the fees in the given month. For example, the funds may be held in escrow at a law firm. If a participant bought ten units at $500,000, then $5 Million would be escrowed as a kind of safety feature for the participant.

Certain embodiments may include a “ 50/50” division of pre-paid fees under a fee prepayment arrangement, e.g., Option B, such that the participant pays half of the pre-paid fees which are due upon entering into the program, but then may wait for a specific period of time, e.g., 35-45 days, before paying the remainder. These features, in conjunction with the features of Option B discussed below, help eliminate both equity ownership concerns, equity ownership limitations, and credit risk associated with the pre-payment of fees to an exchange.

Disclosed embodiments of the invention, and the associated rules of the exchange, are deemed to promote just and equitable principles of trade, to foster cooperation and coordination with persons engaged in facilitating transactions in securities, to remove impediments to and perfect the mechanisms of a free and open market and a national market system and, in general, to protect investors and the public interest. In addition, disclosed embodiments, and the associated rules of the exchange, seek to avoid unfair discrimination between customers, issuers, brokers, or dealers. The relevant exchange rules also provide for the equitable allocation of reasonable dues, fees, and other charges among its members and other persons using its facilities.

In particular, the relevant rules are equitable and not unfairly discriminatory, because all Members may elect to participate (or elect to not participate) in the program described in the disclosed embodiments and earn units on the same terms and conditions, assuming they satisfy the same eligibility criteria. In other words, the eligibility criteria are objective and, thus, all Members have the ability to satisfy them. In practice, the exchange will issue common shares in to any Member that requests designation to participate in the program described in the disclosed embodiments and otherwise satisfies the eligibility criteria to ensure that all Members will have the opportunity to own common shares and thus participate in the program described in the disclosed embodiments if they so choose.

In addition, participant Members will earn warrants on a pro-rata basis upon meeting fixed volume threshold amounts during the measurement periods that will apply to all participant Members. The program described in the disclosed embodiments is equitable and reasonable because an increase in volume and liquidity would benefit all market participants by providing more trading opportunities and tighter spreads, even to those market participants who do not participate in the program. Additionally, the program described in the disclosed embodiments is designed to bring greater volume and liquidity to the Exchange, which will benefit all market participants by providing tighter quoting and better prices, all of which perfects the mechanism for a free and open market and national market system.

Disclosed embodiments, and the associated exchange rules, would increase both intermarket and intramarket competition by incentivizing participant Members to direct their orders to the Exchange, which will enhance the quality of quoting and increase the volume of contracts traded here. To the extent that there is an additional competitive burden on non-participant Members, this is deemed to be appropriate because the program described in the disclosed embodiments should incent Members to direct additional order flow to the Exchange and thus provide additional liquidity that enhances the quality of its markets and increases the volume of contracts traded by the exchange. To the extent that this purpose is achieved, all of the Exchange's market participants should benefit from the improved market liquidity. Enhanced market quality and increased transaction volume that results from the anticipated increase in order flow directed to the Exchange will benefit all market participants and improve competition on the Exchange.

Given the robust competition for volume among options markets, many of which offer the same products, implementing a program to attract order flow like the one being proposed in this filing is consistent with the pertinent government regulations. This is especially true for the smaller options markets which are competing for volume with much larger exchanges that dominate the options trading industry. The disclosed embodiments will help further competition, because market participants will have yet another additional option in determining where to execute orders and post liquidity if they factor the benefits of equity participation into the determination.

### BRIEF DESCRIPTION OF THE DRAWINGS

The following description, given with respect to the attached drawings, may be better understood with reference to the non-limiting examples of the drawings, wherein:

FIG. 1A is a block diagram of an electronic trading platform for providing trading among a number of trading participants according to an example embodiment;

FIG. 1B is a block diagram of a software topology of an electronic trading platform according to an example embodiment;

FIG. 2 is a block diagram illustrating redundant components of a single cloud of an electronic trading platform according to an example embodiment;

FIGS. 3-7 are block diagrams that, when taken together, illustrate an electronic trading platform according to an example embodiment;

FIG. 8 is a flowchart illustrating the processing performed by the matching engine in processing quotes from market makers;

FIG. 9 is a block diagram showing a technological infrastructure for monitoring an equity rights program, pursuant to which units representing the right to acquire equity in the exchange are issued according to certain performance measures;

FIGS. 10-12 are flowcharts depicting a process which uses industry trade data, industry exercise data, and reference data to identify the volume of dividend trades which are to be excluded from the strategic volume calculation; and

FIG. 13 is an example of a generated report which provides, for a particular firm, a summary of the terms of an equity rights deal and the performance of the firm in meeting the terms.

### DETAILED DESCRIPTION

The disclosed embodiments provide a technological infrastructure for administering and monitoring an equity rights program (“Program”), also known as a “Strategic Transaction,” pursuant to which units representing the right to acquire equity in the exchange, e.g., in the Exchange's parent holding company, would be issued to a participating Member (i.e., “Strategic Firm”) in exchange for payment of an initial purchase price or the prepayment of certain transaction fees and the achievement of certain liquidity addition volume thresholds on the Exchange over a specified period. The technological infrastructure produces Strategic Firm Performance Reports, which support the Strategic Transaction by providing a daily report of the performance of each strategic firm against their tranche targets. The technology used to generate these reports is described further below.

The purpose of the Program is to promote the long-term interests of the exchange by providing incentives designed to encourage exchange equity owners and market participants to contribute to the growth and success of the exchange, by being active liquidity providers and takers to provide enhanced levels of trading volume to the exchange's market, through an opportunity to increase their proprietary interests in the exchange's enterprise value.

Members who participate in the Program described in the disclosed embodiments will have at least two options to choose from: (i) an offering of “A-Units;” or (ii) an offering of “B-Units.” A third option, “C-Units” or “C Warrant rebates” is also discussed below.

Members who participate in the A-Unit option of the program described in the disclosed embodiments will be issued units which include, for example: (i) the number of shares of common stock that would result in the holder owning a specified number, e.g., 101,695 shares, of the common stock as of the closing date; and (ii) warrants to purchase common stock of in exchange for such participant Member's initial cash capital contribution of, for example, $508,475, and with such warrants being exercisable upon the achievement by the participating Member of certain liquidity adding volume thresholds on the Exchange during a specified measurement period, e.g., 23 months measurement period commencing on a specified date. Any defined measurement period meeting business requirements may be used, such as, for example, one year, two years, 18 months, etc. The total equity ownership of the exchange's common stock held by any one participant Member will be subject to a cap, e.g., 19.9%.

The warrants will vest in a set number of tranches, e.g., six tranches defined as follows: (i) one tranche, upon initial investment; and (ii) five tranches during a measurement period of months 1-23 of the program. In addition, the participant Members may earn or lose warrants on a pro-rata basis based upon meeting volume commitments during the measurement periods, as detailed below.

Upon the initial investment, the participant Member would receive common shares, e.g., equal to 101,695 shares of the common stock and, e.g., 10% of the warrants will vest. A participant Member will be eligible to earn the remaining warrants during measurement periods provided that the participant has achieved a specified percentage of the total national average daily volume of options contracts reported, e.g., to The Options Clearing Corporation (“OCC”) (“OCC ADV”) on the exchange, of all option classes listed on the exchange. The remaining five tranches, e.g., of 90% of the warrants, will vest during a set of defined measurement periods.

Members who participate in the B-Unit option of the program described in the disclosed embodiments will be issued units consisting of: (i) warrants to purchase common stock in exchange for the prepayment of Exchange fees in the amount of, e.g., $500,000 for the defined period, e.g., 23 months commencing on a specified date. Such warrants will be exercisable upon the achievement by the participating Member of certain liquidity adding volume thresholds during the defined period. Each unit would have the combined ability to acquire, e.g., 1.5% of the outstanding common stock of the exchange as of the closing date. The total equity ownership of the common stock held by any one participant Member will be subject to a cap of, e.g., 19.9%. The warrants will vest in five tranches during a set of defined measurement periods.

In certain embodiments, once a participant Member has prepaid Exchange fees for the defined period, e.g., 23 months, each month the participant Member may execute contracts and accumulate transaction fees based on the exchange's published Options Fee Schedule. Once a B-Unit participant Member has executed contract volume whereby the total accumulated transaction fees equal the prepaid amount allocated to that month, all subsequently executed contracts will be billed at the appropriate rate as defined in the Options Fee Schedule. Each prepaid month will be evaluated separately from each other month. If in any calendar month, a participant Member fails to execute the required contract volume to accumulate total transaction fees equal the prepaid amount allocated to that month, there is no consideration for the unused portion of the prepaid fees.

As discussed above, the purpose of the Program described in the disclosed embodiments is to encourage Members to direct greater trade volume to the exchange to enhance trading volume in exchange's market. Increased volume will provide for greater liquidity and enhanced price discovery, which benefits all market participants. Other exchanges currently engage in the practice of incentivizing increased order flow in order to attract liquidity providers through equity sharing arrangements. The Program described in the disclosed embodiments similarly intends to attract order flow, which will increase liquidity, thereby providing greater trading opportunities and tighter spreads for other market participants and causing a corresponding increase in order flow from these other market participants. The Program described in the disclosed embodiments will similarly reward the liquidity providers that provide this additional volume with a potential proprietary interest in the exchange.

The specific volume thresholds of the program's measurement periods were set based upon business determinations and analysis of current volume levels. The volume thresholds are intended to incentivize firms to increase the number of orders that are sent to the exchange to achieve the next threshold. Increasing the number of orders that are sent to exchange will in turn provide tighter and more liquid markets, and therefore attract more business as well.

Strategic Firm Performance Report Infrastructure

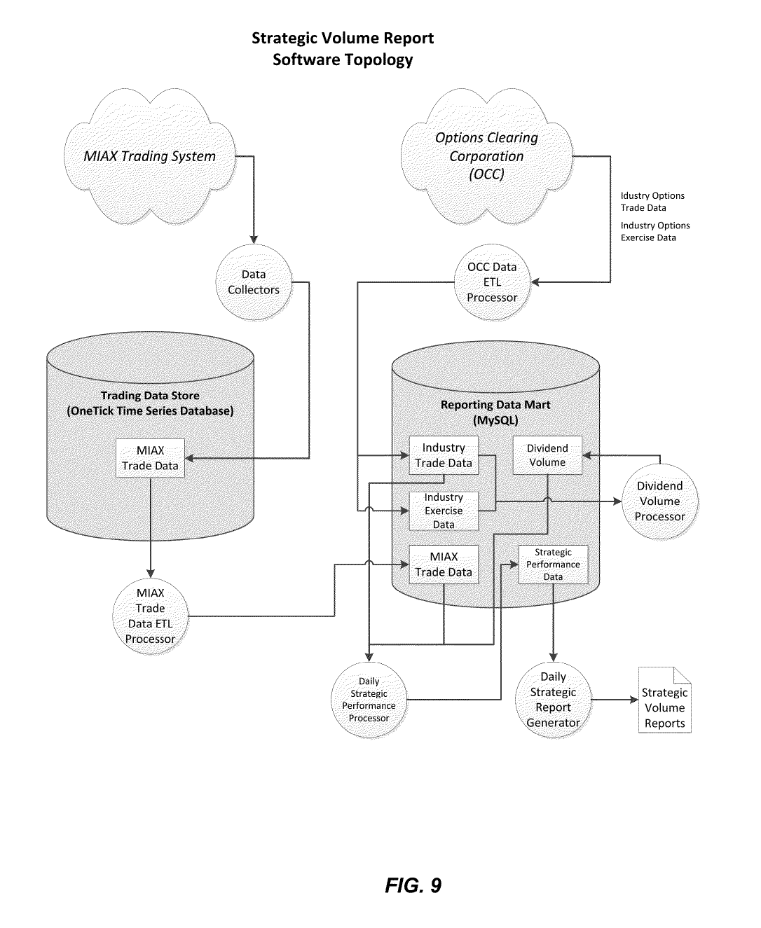

The Strategic Firm Performance Reports produced by the technological infrastructure support the Strategic Transaction by providing a periodic, e.g., daily, report of the performance of each strategic firm against their tranche targets. The technology used to generate these reports includes the components depicted in the topology diagram of FIG. 9 and described below.

Trading System—Data Collectors

The Data Collectors consume the stream of messages (orders, trades, quotes, etc.) generated by the trading system in real-time and store them in a Trading Data Store which runs, for example, on a OneTick Time Series Database (provided by OneMarketData, Hoboken, N.J.). The data collectors may be implemented, for example, as Java-based applications. OneTick is a database which is especially designed to store time-related data in a high speed, low latency manner.

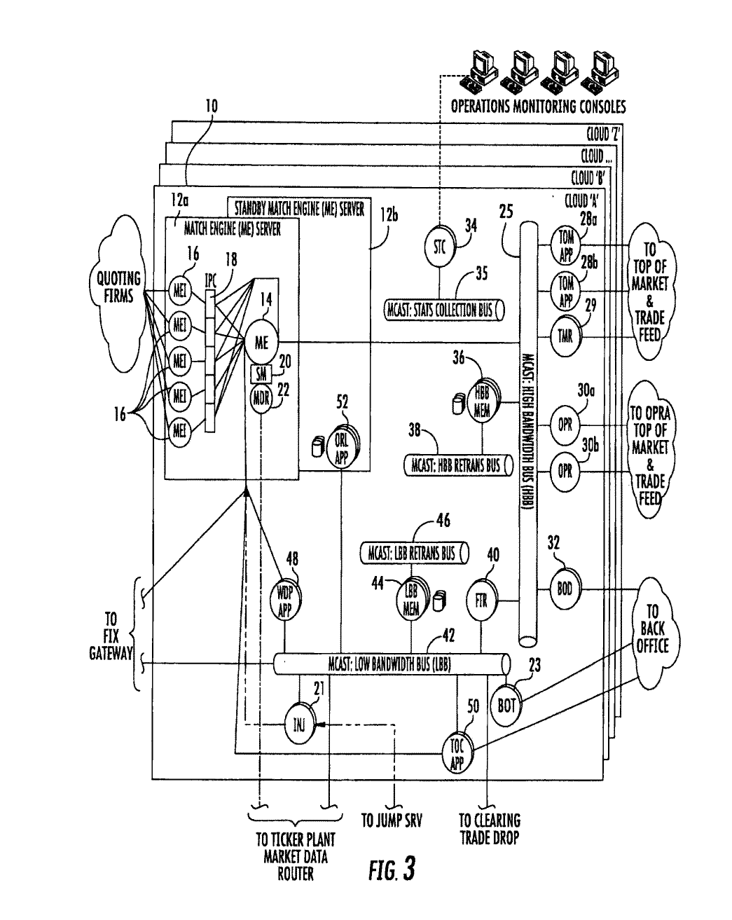

As discussed in further detail below, the trading system (i.e., “MIAX” trading system) outputs orders, trades, and other data to back office systems via a Back Office Drop (BOD) application (see, e.g., FIG. 3, ref. no. 32). The trading systems has various other trade data output feeds, such as, for example, the BOD for Trades application (BOT) (see, e.g., FIG. 3, ref no. 23), which provides a feed to the Business Systems application for sending trade info to the Options Clearing Corporation (OCC) for clearing. In certain embodiments, the BOD application is used to feed trade data from the MIAX trading system to the trading system data collector.

Trade Data ETL Processor

The MIAX Trade Data ETL Processor is a batch process that reads the trade data, e.g., MIAX Options Trades, from the OneTick database. The processor may be implemented, for example, as a Java-based application which runs on a daily basis to read and transform the stored time-based data.

The MIAX Trade Data ETL Processor transforms the trade data into a star schema data model, which is a type of data mart schema in which one or more “fact tables” reference one or more related “dimension tables.” Fact tables typically are used to record measurements or metrics for a specific event, such as a trade or the exercise of an option. Fact tables generally consist of numeric values and keys which are linked to dimensional tables where descriptive information is kept. Dimension tables usually have a relatively small number of records compared to fact tables, but each record may have a very large number of attributes to describe the fact data. Once the trade data has been transformed into the star schema model, the resulting transformed data is stored in the Reporting Data Mart, which runs on database/query software, such as, for example, MySQL (which is an open-source database application from Oracle Corporation).

The following is a list of the fact tables, and related dimension tables, which may be stored in the Reporting DataMart in certain disclosed embodiments.

Fact table: “F_TRADE”. Description: contains option trade details for trades executed on and received from the exchange (i.e., the MIAX Trading system) and loaded by the MIAX Trade Data ETL Processor. Details include, e.g., security symbol, price, volume, member and firm account information and various market state attributes. Dimensional relations: D_MEMBER, based on MEMBER_ID; D_FIRM, based on FIRM_ID; D_UNDERLYING, based on UNDERLYING_ID; D_CLASS, based on CLASS_ID; D_OPTION, based on PRODUCT_ID.

Fact Table: F_INDUSTRY_TRADE_SUMMARY. Description: contains aggregated industry volume statistics received from the OCC and loaded by the OCC Data ETL Processor. Details include, e.g., trade date, exchange code, underlying symbol, security symbol and volume by origin. Dimensional relations: D_UNDERLYING, based on UNDERLYING_ID; D_CLASS, based on CLASS_ID.

Fact Table: F_FIRM_VOLUME_DATA. Description: contains aggregated and denormalized volume statistics by member firm and aggregate industry trade volume as calculated by the Daily Strategic Performance Processor from data in F_TRADE and F_INDUSTRY_TRADE_SUMMARY. Details include, e.g., trade date, firm group code, firm volume by origin, and industry volume by origin. Dimensional relations: None.

Fact Table: F_EXCERCISE. Description: contains aggregated exercise volume by option product received from the OCC and loaded by the OCC Data ETL Processor. Details include, e.g., trade date, option product symbol and exercise volume. Dimensional relations: D_CLASS, based on CLASS_ID; D_OPTION, based on PRODUCT_ID

Fact Table: T_OCC_TRADE_REPORT_SIDE. Description: contains details of each industry trade side received from the OCC and loaded by the OCC Data ETL Processor. Details include, e.g., trade date, option product symbol and volume. Dimensional relations: None.

Fact Table: F_DIVIDEND_REPORT. Description: contains aggregated industry dividend volume statistics as calculated by the Dividend Volume Processor using T_OCC_TRADE_REPORT_SIDE and F_EXCERCISE as inputs. Details include, e.g., trade date, underlying symbol, security symbol, open interest volume, industry volume, industry large trade volume and dividend play volume. Dimensional relations: D_UNDERLYING, based on UNDERLYING_ID; and D_CLASS, based on CLASS_ID.

OCC Data ETL Processor

The OCC Data ETL Processor is a batch process which reads two sets of data that are sent by the Options Clearing Corporation (OCC), the central clearing utility of the options industry. The processor may be implemented, e.g., as a Java-based application, and may perform the processing periodically, e.g., daily. The OCC provides various data distribution services in the form of trade-related data feeds for options trades, including, for example: industry-wide Options Trade Data (i.e., trade data from all exchanges); and industry-wide Options Exercise Data. The OCC Data ETL Processor parses these files, which are in XML format, transforms the data into a star schema data model and stores them in the Reporting Data Mart.

Dividend Volume Processor

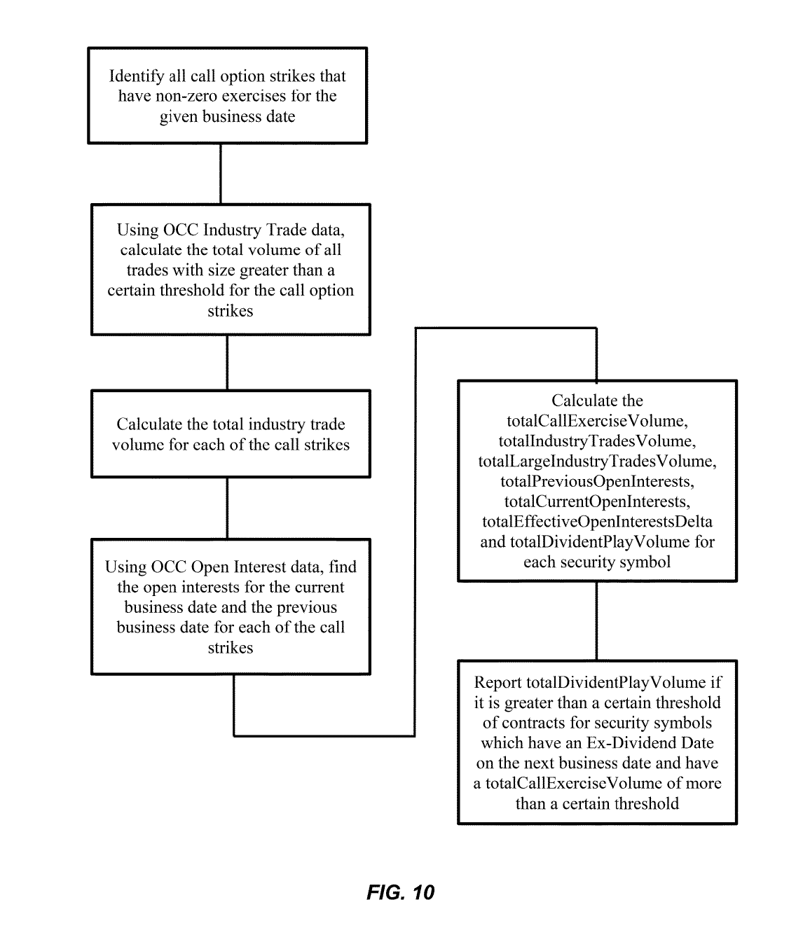

The Dividend Volume Processor is a batch process that uses the Industry Trade Data and the Industry Exercise Data that is stored in the data mart, and also reference data that identifies ex-dividend dates for all securities, to identify the volume of dividend trades which are to be excluded from the strategic volume calculation, i.e., trades which were made as part of a dividend-play strategy. The process calculates the volume of these trades for each trade data and stores the results in the Reporting Data Mart. Such a process is necessary because the industry trade data does not distinguish between dividend trades and ordinary trades. The process is described in the flow charts of FIGS. 10-12

As shown, for example in FIG. 10, the dividend volume process begins by using OCC Industry Exercise data to identify all call option strikes that have non-zero exercises for the given business date (i.e., “CallExcerciseVolume”). Using OCC Industry Trade data, the total volume of all trades with size greater than a certain threshold calculated (e.g., a quantity threshold of 1,000) for the above-mentioned call option strikes (i.e., “LargeIndustryTradeVolume”). The total industry trade volume for each of the above-mentioned strikes is calculated (i.e., “IndustryTradeVolume”). Using OCC Open Interest data, the process finds the open interests for the current business date and the previous business date for each of the above-mentioned strikes (i.e., “PreviousOpenInterest” and “CurrentOpenInterest”).

The process then calculates the totalCallExerciseVolume, totalIndustryTradesVolume, totalLargeIndustryTradesVolume, totalPreviousOpenInterests, totalCurrentOpenInterests, totalEffectiveOpenInterestsDelta and totalDividendPlayVolume for each security symbol. The process reports totalDividendPlayVolume if it is greater than a certain threshold of contracts (e.g., a threshold of 1,000) for security symbols which have an Ex-Dividend Date on the next business date and have a totalCallExerciseVolume of more than a certain threshold (e.g., 1,000).

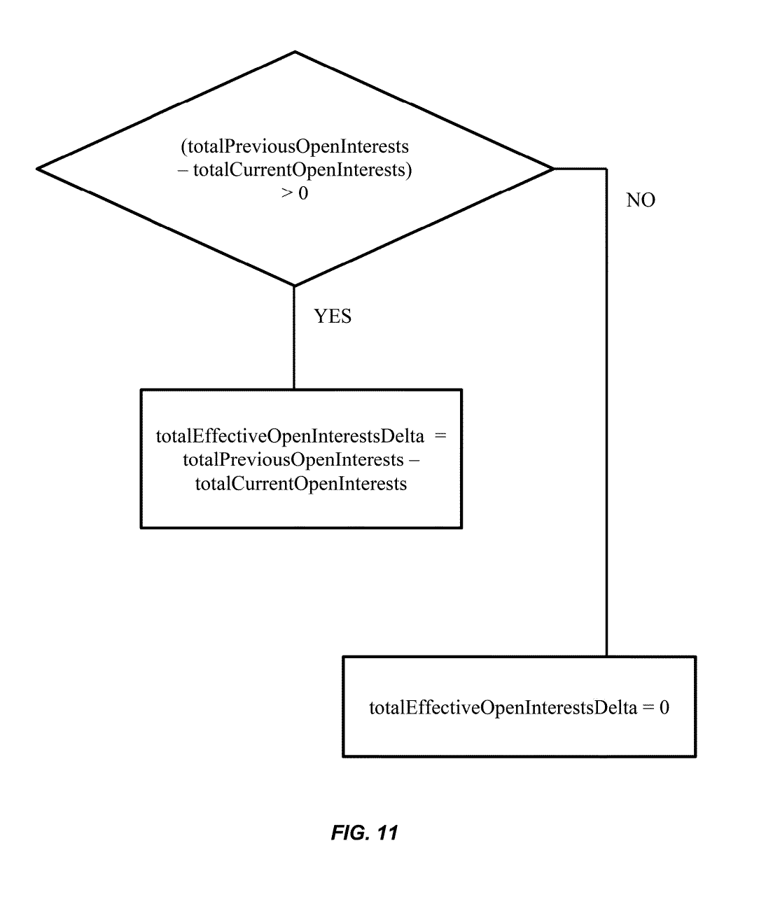

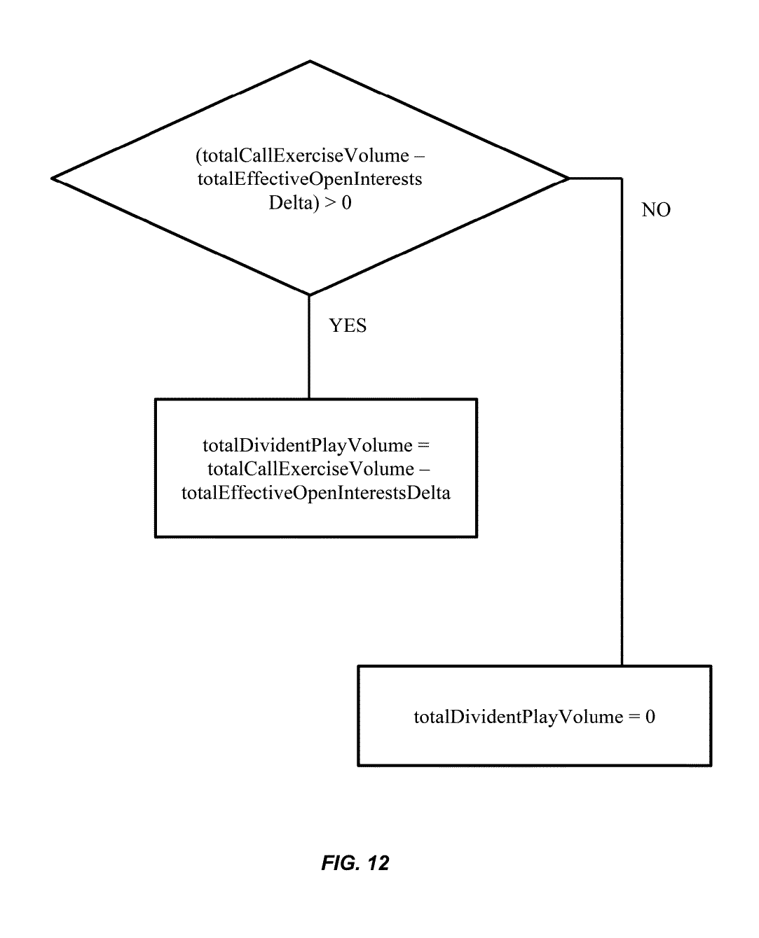

FIGS. 11 and 12 show the details of the calculation of totalDividendPlayVolume for each security, which is the total volume executed as part of a dividend-play strategy.

As shown in FIG. 11, a parameter, total EffectiveOpenInterestsDelta, is calculated using the following logic: if (totalPreviousOpenInterests−totalCurrentOpenInterests)>0; then, totalEffectiveOpenInterestsDelta=totalPreviousOpenInterests−totalCurrentOpenInterests; else, totalEffectiveOpenInterestsDelta=0.

As shown in FIG. 12, the totalDividendPlayVolume is calculated using the following logic: if (totalCallExerciseVolume−totalEffectiveOpenInterestsDelta)>0; then, totalDividendPlayVolume=totalCallExerciseVolume−totalEffectiveOpenInterestsDelta; else, totalDividendPlayVolume=0.

Daily Strategic Performance Processor

The Daily Strategic Performance Processor is a batch process that consumes multiple data sets from the Reporting Data Mart, including, for example: industry trade data; exchange trade data; dividend volume; and reference data defining the equity rights deal terms tranches, units subscribed and performance target per unit (examples of the reference data for defining equity rights deal terms are discussed below in the section entitled “Performance Criteria for the Warrants”).

Using these data sets, the Daily Strategic Performance Processor calculates the following for each participating member for each tranche and stores the results in the Reporting Data Mart: firm volume; adjusted OCC volume in Exchange classes (i.e., industry trade volume excluding dividend trades); realized performance; performance relative to target; required performance over the remaining trading days to reach 100% of the target; and required performance over the remaining trading days to reach 70% of the target.

For any given period, the realized performance may be determined based on the firm volume (i.e., the volume traded by the participating member in the MIAX trading system) divided by the adjusted OCC volume in exchange classes. The realized performance can then be compared to the volume thresholds for the respective participating member and respective time period (i.e., “tranche”), as described in further detail below.

Daily Strategic Report Generator

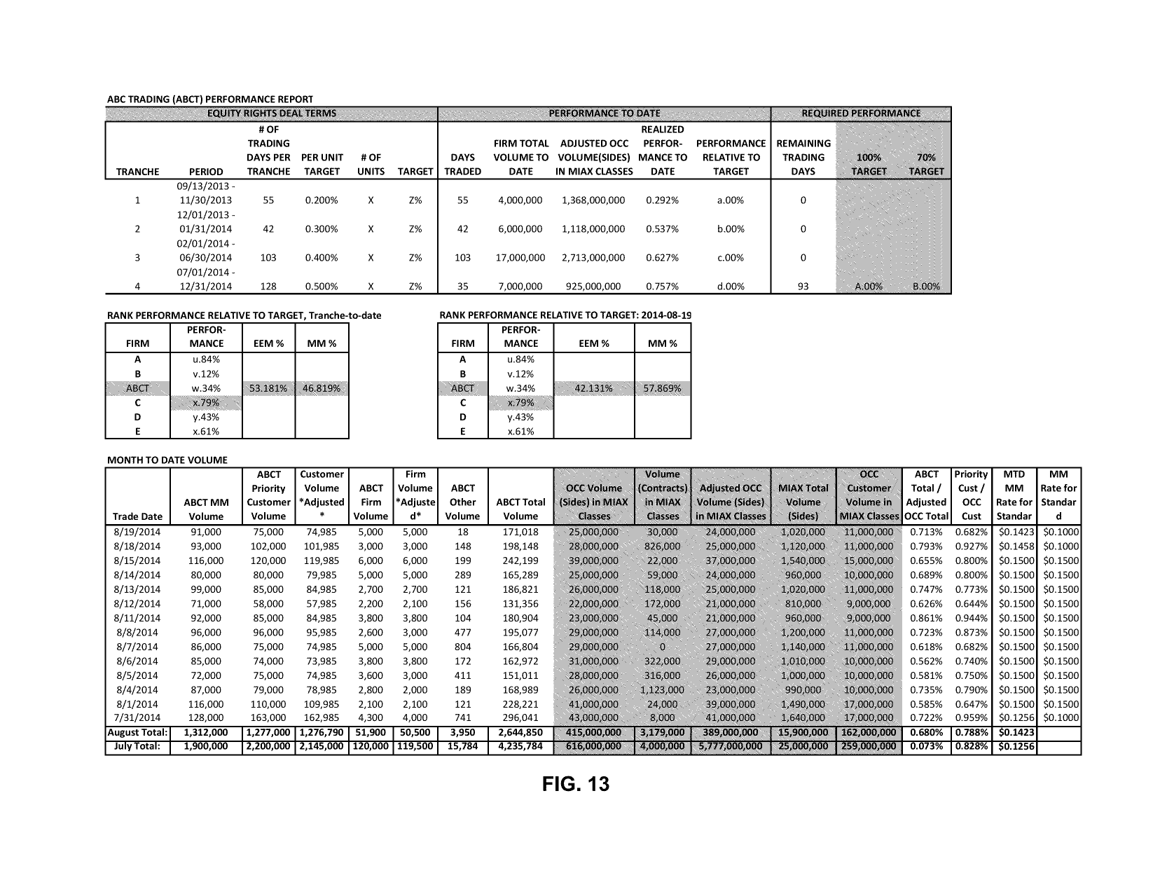

The Daily Strategic Report Generator is a batch process that uses the statistics captured by the Daily Strategic Performance Processor and generates a formatted report (e.g., a Microsoft Excel spreadsheet) for each firm (i.e., participating member) and the exchange (i.e., the MIAX trading system) as a whole, as shown, for example in FIG. 13. The report generator may be implemented, for example, as a Java-based application. The report generator may also use software tools specifically designed to produce spreadsheet reports, such as, for example, Apache POI, which is an open-source Java Application Program Interface (API) which generates Microsoft Office documents, such as Excel spreadsheets.

As shown in FIG. 13, in one embodiment, the generated report provides, for the particular participating member (i.e., firm), a summary of the terms of the equity rights deal and the performance of the firm to-date in meeting the terms. As described in further detail below, the equity rights deal terms may involve a series of tranches, each of which covers a particular period of time (note: in this example, alphanumeric characters are used as placeholders for certain values which would appear in an actual report). The performance to-date includes the firm in total trading volume to date, the adjusted OCC volume in classes traded on the exchange (i.e., trades which have taken place outside of the exchange in classes which are available on the exchange). The ratio of these values yield a percentage value which may be compared to a target percentage for the particular tranche in question.

The report may also include an indication of how the firm in question ranks with respect to a group of other participating members, i.e. firms, both for the current tranche as well as for a year-to-date period. The report may also include a month-to-date volume table which lists the firm trading volume on a daily basis compared to trading done by the firm outside of the exchange, i.e., based on OCC trading data adjusted to exclude dividend trades, as described above.

The Exchange/MIAX Trading System

The Exchange, i.e., the trading system, may be implemented using a system architecture such as that described below.

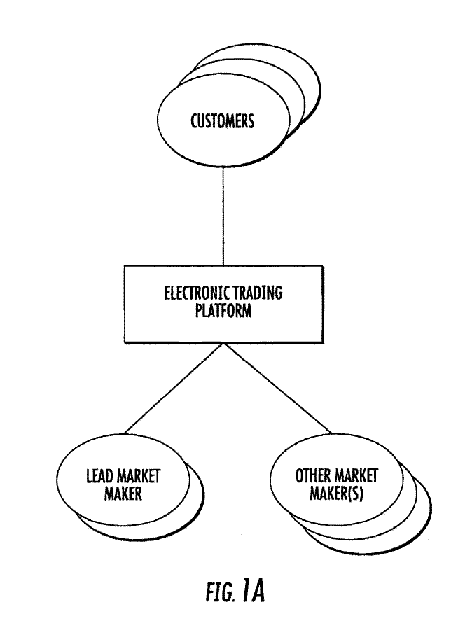

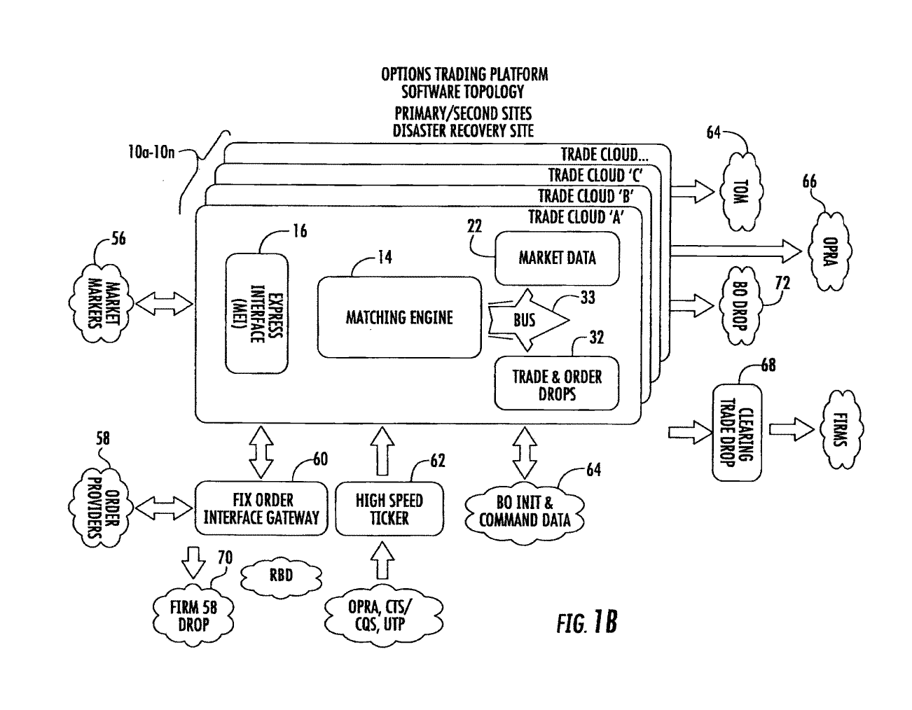

FIG. 1A is a highly schematic diagram of an electronic trading platform that facilitates trades between a number of possible trading parties. An electronic trading platform may comprise a series of interconnected computers for communicating between the trading parties and a centralized computer system acting as the Exchange. The centralized computer system is preferably formed of at least one parallel processing computer that records the interactions between the trading parties and matches bids and offers as described more fully herein. The computer system includes at least one computer processor, digital computer memory and non-transitory nonvolatile storage devices (e.g., hard disk drives, disk arrays, and/or EEPROM/Flash memory arrays). The computer system further includes computer code stored in the digital computer memory (potentially having been read from the non-volatile storage devices) for controlling the computer processor to perform steps defined by the computer code. The computer code controls the computer system to perform the processing described herein.

The components of the electronic trading platform are configured to perform trading of one or more types of financial instruments (e.g., equities or options). In one embodiment of the electronic trading platform, incoming interests (e.g., quotes and orders) in a tradable financial instrument are analyzed to determine if there is a matching contraside interest (e.g., an initiating (i.e., incoming) offer matching an existing (i.e., resting) bid or an initiating bid matching a resting offer for some number of contracts). If there are matching contraside interests resting, the system may perform automatic allocation of the interests according to, e.g., the trading rules of the system.

To meet the performance demands of the trading industry, an electronic trading system according to an example embodiment employs a number of architectural design techniques and various technologies described in greater detail below to provide ultra-low latency and high throughput performance.

To meet processing throughput and latency demands of the architectural objectives, an electronic trading system according to an example embodiment is componentized to create a distributed processing software system. That is, the logical processing of various tasks is localized into software components that allows for their distribution across multiple CPU's throughout the hardware platform. This componentization allows for parallel processing where the opportunity exists and, therefore, a higher performance.

A trading system architecture according to an example embodiment provides performance metrics including 20+ million quotes per second, 35 microsecond average round trip time of a quote with no system load and 125 microsecond average round trip time for orders routed, e.g., through a FIX Gateway.

As will be described in greater detail below, an electronic trading platform according to an example embodiment uses multicast messages as a primary method for messaging throughout the distributed Trading System platform. Because multicast, by virtue of the multicast protocol, entails the replication and distribution of messages to subscribing joiners at the network hardware layer to the multicast groups, the use of this protocol supports the distributed nature of the Trading System software design and ensures fair access to all subscribers. An electronic trading platform according to an example embodiment provides a messaging infrastructure (described in more detail below) that guarantees the delivery of multicast message traffic to all destinations within the Trading platform, even though the multicast protocol itself does not guarantee the delivery of such traffic.

An electronic trading platform according to an example embodiment comprises 10 Gbit Ethernet network technology to provide both speed and stability at the network infrastructure layer. 10 Gbit Ethernet provides an extremely fast network transport as well as a time-tested reliable technology. Additionally, because Ethernet is a mature technology, it benefits from vast support for network analysis, monitoring and control. Furthermore, the electronic trading platform may comprise 10 Gbit network interface cards that feature accelerated Ethernet network processing. This technology provides faster processing of transport control protocol (TCP), user datagram protocol (UDP) and multicast traffic. Use of this technology enhances the performance of the electronic trading platform by more quickly processing traffic read off of the network wire and passing it up to an application (e.g., a matching engine) for processing, eliminating the overhead associated with passing data through the system kernel.

An electronic trading platform according to an example embodiment comprises a performance monitoring capability that provides an in-depth view of all services (e.g. FIX Order Interface, local exchange Express Interface, Top of Market Feed, etc., described in more detail below) throughout the electronic trading platform. Each application service produces latency and throughput metrics that are displayed in real-time to System Operations. This provides in depth access of the Trading System's performance to enable the observation and trending of performance related metrics.

In keeping with the goal of providing high throughput while managing the size of the data center footprint, an electronic trading platform according to an example embodiment provides scalability by creating multiple independent trading environments (a.k.a. “clouds”) consisting of a dedicated set of independent Trading System software processing components that, as a collection, conduct all of the functional processing necessary for trading.

According to an advantageous feature of the present invention, a suite of symbols are traded across the multiple clouds, and are thereby load balanced. So, for example, the range of symbols traded on the local exchange are split across the plurality of clouds. Thus, each cloud might perform trading for a subset of all the traded symbols (a stock symbol or ticker symbol being an abbreviation used to uniquely identify publicly traded shares of a particular stock on a particular stock market), or even a single symbol, for very highly traded instruments. Such load balancing of traded symbols aids performance because it distributes the load across multiple trading environments and provides the electronic trading platform with the flexibility to move trading products between clouds based on resource usage.

As shown in FIG. 1B, each cloud, i.e., collection of components, e.g., clouds 10a . . . 10n, is operationally independent from all other clouds such that all operational commands, controls and monitoring tools are “cloud aware.” System Operations may thus easily identify and operate each cloud individually or collectively. Additionally, the electronic trading platform has a structured cloud configuration model that greatly facilitates a process for instantiating additional clouds.

FIG. 1B is a block diagram of an electronic trading platform according to an example embodiment. By virtue of the trading cloud approach and the operational support built into an operations configuration and command suite of example embodiments, the electronic trading platform has the built-in capability to readily scale the software as the demand for performance increases. A cloud is a logical grouping of services hosted on shared infrastructure and controlled internally within Data Centers facilitating trading on predefined groups of options. Based on the architecture, selected core applications (or multiple instances of the same application) are “cloud specific” and other applications are designed to be “cloud agnostic.”

As can be seen in FIG. 1B, market makers 56, i.e., quoting firms, submit quotes, and receive information from, the matching engine 14, by communicating with an MEI application 16. The MEI application 16 receives quotes, typically block quotes, from market makers 56, and, as will be described in greater detail below, stores the quotes in a shared memory accessible by the matching engine 14 for use, e.g., in matching, by the matching engine 14, the received quotes with contra-side orders. Thus, as can be seen in the figure, each cloud is configured to facilitate bidirectional communication with market makers 56 using the MEI application 16.

Order providers 58, on the other hand, communicate indirectly with the cloud via a FIX interface gateway 60. Unlike the MEI application 16, the FIX interface gateway 60 is not specific to a cloud. Rather it is used by all the clouds. The FIX interface gateway 60 has logic that determines the symbol associated with the received orders and routes the orders to the IP address of the appropriate cloud. Thus, for example, the FIX interface gateway 60 has a look up table to associate the symbol, cloud, and IP address of the cloud, and then transmit the order to the appropriate IP address in the message to be sent to the cloud (and matching engine) on which the order will be executed.

Each cloud's matching engine 14 additionally receives information about the current state of the market from the high speed ticker 62, which forwards quote information from OPRA, CTS/CQS and UTP, for example to ensure that the matching engine 14 is informed of the situation in the market as a whole. As will be described in more detail below, the matching engine 14 accesses this market information also from a shared memory.

The matching engine (ME) 14 provides market data to outside of the trading system, for example, for customers that may wish to take or hit an order resting on the system's book. For this purpose, each cloud, based on the activity of the matching engine 14, updates a top of market feed (TOM) 64, which is provided, based on all the information received by, and matching performed by, the matching engine 14, via the market data 22. The same information is also provided to OP RA 66, as required by U.S. trading regulations.

The architecture supports multiple instances of the core Quoting Interface (MEI application) 16 on a single cloud, the multiple instances being shown more clearly in figures to be discussed below. The matching engine 14 and outbound OPRA Feed applications (incorporated in the market data 22 in the high level depiction of FIG. 1B) are cloud specific, having at least a single instance per cloud. Fix Order Interface ((FOI) 60 applications—which provide an order entry interface and routing to the appropriate cloud application and other similar applications, are cloud agnostic because they are run or executed outside of any specific cloud. A cloud based architecture thus provides maximum flexibility from a scalability and performance point of view.

Incoming information as to the state of the market is received by the matching engine 14 from the high speed ticker 62, which includes, e.g., OTP, CTP and UTP information, developed from OPRA, CTS/CQS and UTDF/UQDF information sources. Completed trades are dropped to the Firm 58 drop 70 for billing. All orders, trades, reference data and BBOs are send to the BO (Back Office) Drop 72 for storage in the back office of the trading system.

Data published/disseminated from each cloud is available for consumption on a central messaging bus backbone. This backbone is shown in more detail in figures below and is shown highly schematically as Bus 33 in FIG. 1B. Different applications, based on their business logic, subscribe to the messages disseminated and perform their required actions responsively thereto. The central messaging backbone architecture facilitates reduced latency and allows for more scalability as needed. Each application has discrete functionality and, in case of any unexpected erroneous behaviors, becomes less complex to recover functionality accordingly.

The cloud architecture further lends itself to optimized symbol balancing which ensures each matching engine 14 can consistently cater to different spikes in quote throughput rates and trading volume on certain option(s) class. Each cloud also sends trade data to the clearing trade drop 68, which performs an entitlement based clearing trade interface for trading participants. The results of the clearing are send to the trading firms.

An electronic trading platform according to an example embodiment achieves hardware scalability by employing a container concept to server and network hardware platforms. The container concept localizes all network and server hardware into a grouping that is insulated from other containers. For example, a Trading System container is independent from a Back Office Systems container. This greatly facilitates the scaling of a given container as it is isolated from other containers thereby reducing the network integration points to points of the container being expanded.

An electronic trading platform according to an example embodiment provides high resiliency and narrow fault domains with fully redundant services throughout the architecture. Software resiliency is achieved by various techniques via a suite of redundant services. At the software layer within the electronic trading platform, the platform provides redundant backup applications for each of the Trading System software applications in one of three options: 1) Hot-Hot; 2) Hot-Warm; and 3) Hot-Cold.

A Hot-Hot paradigm for achieving software resiliency is preferred. However, not all software problem domains allow for such an approach. For example, in some cases the message processing capacity requirements precludes a Hot-Hot approach. In some cases, where there is an external interface, a Hot-Hot approach may not be feasible for the external entity utilizing the given interface. Additionally, the complexity of a given functional problem may make Hot-Hot processing extraordinarily complex and thereby create enough risk that it outweighs the benefit. In these instances, an electronic trading platform according to an example embodiment may employ a Hot-Warm approach to failover as a secondary approach to meeting resiliency demands.

In a Hot-Warm approach, failing over to a backup application is greatly facilitated by virtue of the backup application's runtime state being synchronized with the primary application. Therefore, failing over to the backup application is mainly reduced to activating the backup application's mode from backup to primary. A Hot-Cold approach may be used where neither a Hot-Hot nor Hot-Warm approach is viable. For example, a Hot-Cold approach is utilized when coordination with an external participant is required and when such coordination may take a non-deterministic duration to complete.

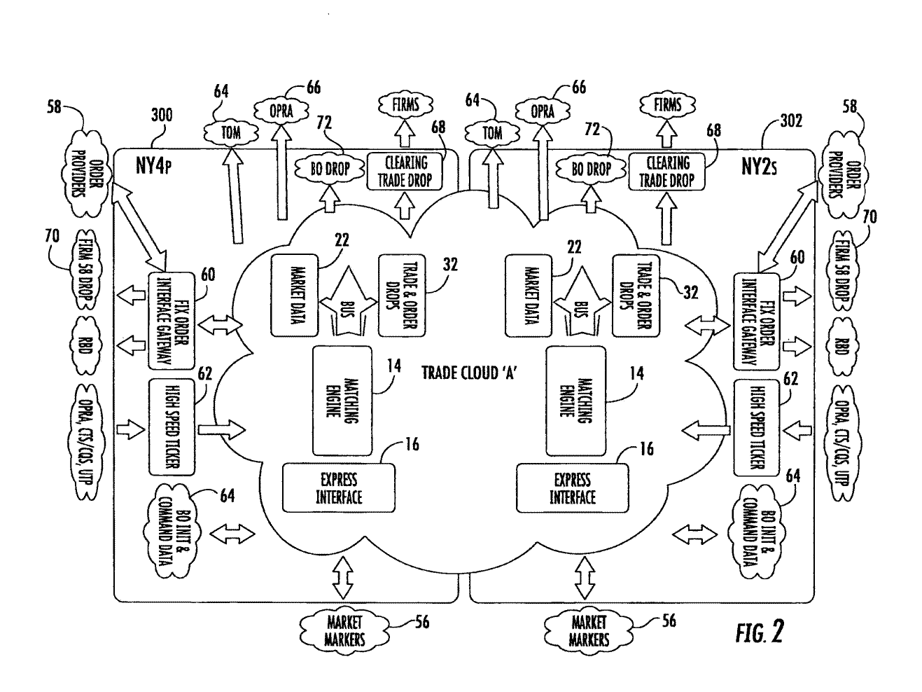

FIG. 2 is a block diagram illustrating redundant components of a single cloud of an electronic trading platform according to an example embodiment. In addition to multiple clouds, each handling trades on a symbol basis, the trading system, in accordance with the present invention, also has, for each cloud, redundancy, for example by location. This is shown in FIG. 2, using multiple instances of the components previously set forth in the diagram of FIG. 1B to achieve hardware resiliency. The components perform the same functions as discussed in connection with FIG. 1B and their individual functions will not be repeated here in relation to FIG. 2.

As illustrated in FIG. 2, to achieve server hardware resiliency, software of the electronic trading platform is configured such that all primary applications run on server hardware residing in a primary data center 300 (NY4P) and all backup applications run on redundant server hardware residing at a secondary data center 302 (NY2S). The electronic trading platform thereby achieves two benefits: 1) if a server failure occurs, because the backup application software runs on a redundant server, the system provides resiliency at the server level; and 2) if a data center failure occurs at NY4, since all backup software runs on redundant servers located at a secondary data center, the system provides data center resiliency. The proximity of NY4 and NY2 ensures that no latency factors are introduced as a result of switching between the primary and secondary server.

Narrowing the impact of faults is an architectural objective of example embodiments because it limits the negative impact of such faults on operations while the redundant services are being introduced. An electronic trading platform according to an example embodiment narrows the impact of failure by creating software components as discrete functional units assigned to provide services to as narrow of a service domain as is feasible. For example, a Clearing Trade Drop (CTD) service is a client facing service that is designed as a collection of discrete application instances with each discrete instance servicing only a single client. A failure of a given instance thereof thus affects only a single client. This is one of the ways the electronic trading platform narrows the fault isolation at the software layer for client facing applications such as CTD, the FIX Order Interface (FIO) and the Express Interface (MEI).

For applications that provide server facing services, for example a Watch Dog/Purge (WDP) server application, the applications are localized into each cloud and limited to providing services to the assigned cloud only. A failure of a given server oriented service is thus limited in scope to the given assigned cloud. With numerous clouds providing trading services, this helps insure that, in the event of a failure of a server facing application, other clouds are insulated from impact.

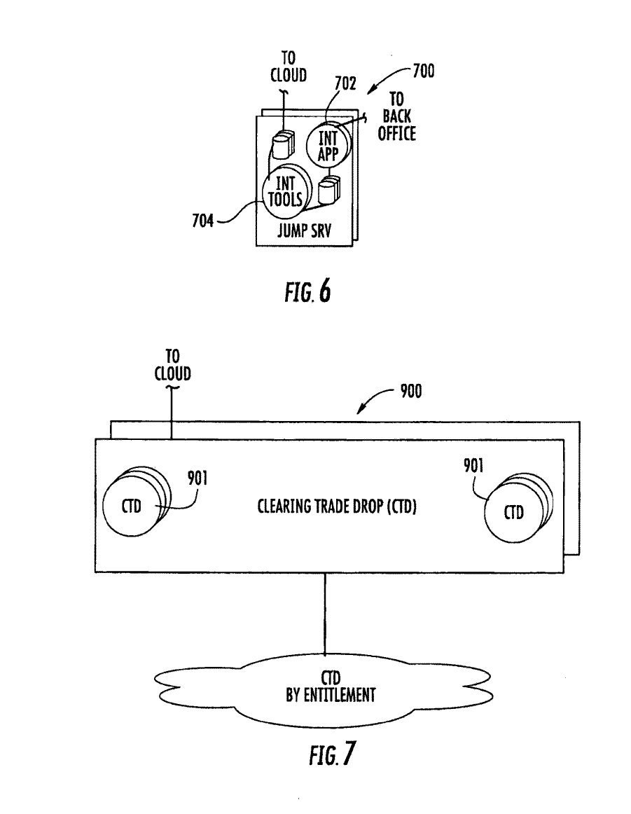

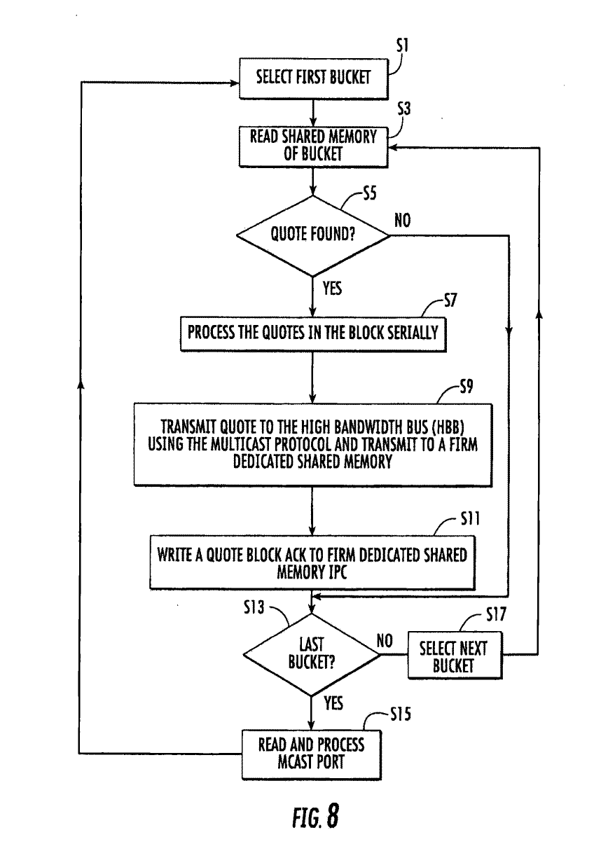

FIGS. 3-7 illustrate flexible software and hardware architecture attributes of an electronic trading platform according to an example embodiment. Software architecture of the electronic trading platform provides adaptation to trade securities instruments, including, e.g., options, equities and futures. Using componentization, centralization of business logic and elimination of reliance on the underlying product symbology at the software architectural layer and object oriented programming languages such as C++ at the software layer, an electronic trading platform according to example embodiments is more easily customized for new functionality or new product sets. The software architecture's performance characteristics meet the characteristics required to trade all types of instruments.

An electronic trading platform according to example embodiments shown in FIGS. 3-7 comprises applications that are grouped into at least two different domains based on their roles, namely, Trading Systems and Business Systems. In the example, it will be assumed for purposes of illustration that the system is an Options Trading System. However, the Trading System also is applicable for trading of any tradable securities and derivatives. The Trading System supports the following operational activities: all automated options trading activities, data forwarding to Business Systems for: Trading Operations Help Desk Support, Surveillance, Trade clearing and Billing and Data, forwarding to OPRA for: Trade Reporting and local exchange BBO dissemination. The electronic trading platform supports the following customer interfaces: FIX Order interface (FOI) 401 in the FIX Gateway 400, Quoting Interface (MEI) 16, Clearing Trade Drop 900 and Top of Market Feed 28. Market Data Inputs are supported by the electronic trading platform via a High Speed Ticker 500 from an Underlying Market Data interface (CTA app 504, UTP app 506) and an OP RA market data interface app 502.

An electronic trading platform according to an example embodiment may run on RED HAT Linux 6.1 Enterprise Version 64 bit. Proprietary software components may be developed using the C++ language.

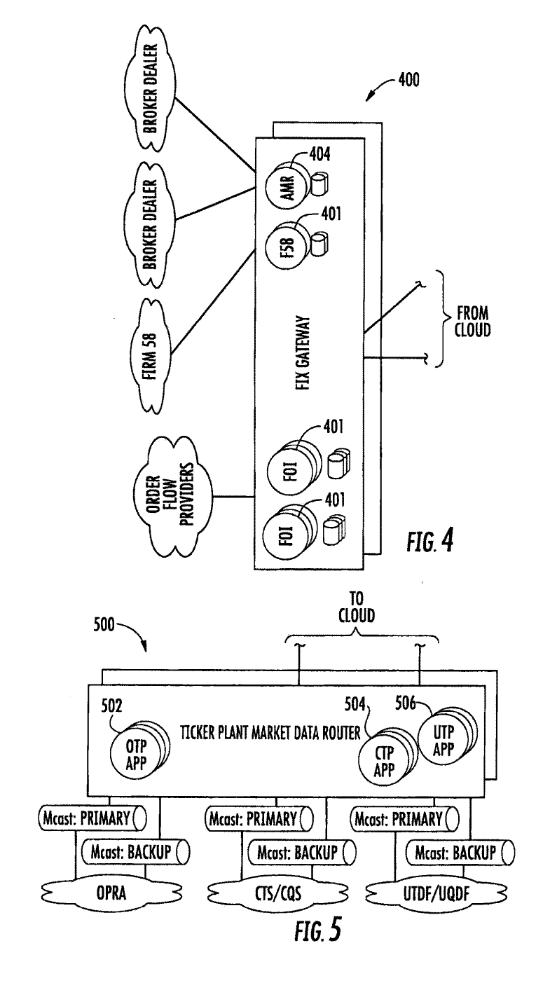

FIG. 3 illustrates in detail a single cloud of the multi-cloud electronic trading platform and FIGS. 4-7 illustrate the components of the trading system outside of the cloud. The predominant information provider to applications in the cloud is the matching engine 14, whose output, including reports of all trades, is sent in a plurality of multi-cast messages to the MCAST High Bandwidth Bus 25, from which the information is accessible by other applications. As will be discussed in greater detail below, the matching engine 14 generates trade data based on quote and order information it receives from the MEI 16, in the case of quotes, and from the FIX gateway 400. As will be described in greater detail below, the matching engine 14 reads block quotes from market makers that have been placed into shared memory by the MEI 16, of which each cloud may have multiple instances. The matching engine 14 does not receive interrupts from the MEI 16 to inform it of the presence of quotes. Rather, the matching engine 14 reads the shared memory, in round robin fashion, and, as quote blocks are found, handles the quote blocks in their entirety before moving on to a different task. Once a quote block has been handled, the matching engine 14 checks its MCAST port to handle any requests for information that may have come in the meantime, again handling all of these requests over MCAST before next reviewing the shared memory for additional quote blocks. The matching engine in never accessed via an interrupt, and thus atomically addresses quote blocks, and MCAST messages, for example, in their respective entireties, before moving on to another task.

With regard to other applications on the cloud, the cloud may comprise, for example, two instances of Top of Market application (TOM), in this case 28a and 28b. The TOM application (28a, 28b) provides a Proprietary Trade and local BBO Feed to Subscribers (available to all exchange members and to non-members) and has a HOT-HOT failover design. The TOM application (28a, 28b) leverages a centralized logging mechanism for capturing warning and error conditions. Real-time application activity and performance monitoring is accomplished via a customer monitoring application.

Each cloud also includes a TOM Retransmit application (TMR) 29. The TMR application 29 is a retransmission service for the TOM (28a, 28b) and has a HOT-HOT failover design. The TMR application 29 leverages a centralized logging mechanism for capturing warning and error conditions and provides real-time application activity and performance monitoring. The BO Drop application (BOD) 32 provides a Feed to the Business Systems of all Cloud Traffic, including orders, trades, BBOs, reference data, to the back office, with value added content and has a HOTWARM failover design. The BOD for Trades application (BOT) 23 provides a Feed to the Business Systems application for sending Trade info to the Options Clearing Corporation (OCC) for clearing and has a HOT-WARM failover design. The BOD for Trades application (the function of which is incorporated in the BOD 32 but is for trades only) leverages a centralized logging mechanism for capturing warning and error conditions with real-time application activity and performance monitoring accomplished via a customer monitoring application.

An OPRA Outbound application (OPR) 30a, 30b provides a Trade and local exchange BBO Feeds to OPRA and has a HOT-WARM failover design. The OPR application 30a, 30b leverages a centralized logging mechanism for capturing warning and error conditions with real-time application activity and performance monitoring accomplished via a customer monitoring application.

An Initialization download application (INT app 702) runs in the Jump server 700 and provides an interface to the Business Systems, such as the back office, for submitting initialization data to the Trading System, and has a HOT-WARM failover design. The INT application 702 leverages a centralized logging mechanism for capturing warning and error conditions. An Initialization Injector application (INJ) 21 injects initialization content into the matching engine 14 for distribution into the trading cloud and has HOT-WARM failover design. The INJ application 21 leverages a centralized logging mechanism for capturing warning and error conditions.

An Initialization Tools application (INT tools) 704 is in the Jump server 700 and verifies Initialization Data and has a stand-alone failover design. The INT tools application leverages a centralized logging mechanism for capturing warning and error conditions.

The watchdog (WDP) application 48 provides automatic quote protection in case of a firm wide disconnect by automatically purging quotes for a given Market Participant Identifier (MPID) on a given cloud. The Watchdog/Purge application (WDP) 48 is a watchdog application configured to purge on MEI disconnects/MEI failures. It also functions to unravel MPID purges into underlying purges. An MPID authorizes a firm to trade options of the underlying stocks. Therefore, an MPID maps to multiple underlyings. For example, MPID123 maps to stocks DELL, IBM and HP. An MPID purge allows a firm to request a purge to MPID123, in which case the WDP 48 can in turn purge DELL, IBM and HP for that MPID, essentially purging all options with DELL, IBM or HP.

The WDP application 48 has a HOT-WARM failover design and leverages a centralized logging mechanism for capturing warning and error conditions with real-time application activity and performance monitoring accomplished via a customer monitoring application.

A Filter application (FTR) 40 creates a Low Bandwidth Bus (LBB) 42 from a High Bandwidth Bus (HBB) 25 by filtering out all bus configured traffic from the Trading System and sends remaining data to its recipients (e.g. the FIX Order Interface 401 in the FIX Gateway 400, Ticker Plant 500, etc.) and has a HOT-WARM failover design. Thus, as shown in the figure, each cloud of the electronic trading platform according to an example embodiment accordingly has separate HBB and LBB buses 25 and 42, respectively, shown in FIG. 3, and the FTR application 40 filters a portion of the data from the HBB for distribution on the LBB. The FTR application 40 leverages a centralized logging mechanism for capturing warning and error conditions with real-time application activity and performance monitoring accomplished via a customer monitoring application.

A MEM application including HBB MEM 36 and LBB MEM 44 collects all bus traffic and services replay requests and each has a HOT-HOT failover design. The MEM applications plug into a multicast stream, and receive and store all messages. The MEM applications also respond to gap fill requests from the edge applications in the event that an edge application perceives a gap in the message stream. The MEM applications have “plug and play” capability in production in the sense that a new MEM can be introduced in the network in the event that others MEMs experience a hardware failure. The MEM applications uses the Multicast Agile Communication Highway (MACH) protocol API, discussed in more detail below, for receiving inbound messages. The MEM applications may use either unicast or TCP Session Management (SesM) protocol to handle gap fills depending upon a size of the gap fill request. In particular, the HBB MEM 36 connects with the MCAST HBB retransmission bus 38 for retransmitting messages that were lost during a gap in transmission, and the LBB MEM 44 connects with the MCAST LBB retransmission bus 46 for retransmitting messages that were lost during a gap in transmission. The MEM applications leverage a centralized logging mechanism for capturing warning and error conditions with real-time application activity and performance monitoring accomplished via a customer monitoring application.

An Express Interface application (MEI) 16, multiple instances of which are preferably provided for each cloud, supports liquidity provider, i.e., quoting firm (market maker) access to the local exchange (Interface App) and has a HOT-HOT failover design. For a particular cloud, each instance of the MEI application 16 is associated with a particular quoting firm, and is also associated with a particular area, or “bucket” in the IPC 18. As can be seen in FIG. 3, each MEI 16 is in communication with a particular area/bucket of the IPC 18. Quote blocks from the associated quoting firm are placed in a respective associated bucket reserved for that firm.

The MEI 16 also leverages a centralized logging mechanism for capturing warning and error conditions with realtime application activity and performance monitoring accomplished via a customer monitoring application. Each instance of the MEI 16 communicates with its associated market maker (quoting firm) and places quote information, preferably block quotes, from that associated firm directly into the appropriate bucket in the shared memory IPC 18, without interrupting the matching engine 14. As will be described in more detail below, the matching engine 14 checks buckets of the shared memory IPC 18 to determine if quotes are present that need to be processed.

The matching engine (ME) 14 supports all trading logic for the system, handling all trade processing, and has a HOT-COLD failover design. The ME 14 handles reading, validation processing for the purpose of handling quotes for the Quoting Firms, via the MEI 16, and orders from order flow providers, via the FIX gateway 400. Quotes provide liquidity and typically the price of the market for each option product. Orders, on the other hand, take liquidity from the market, by a participant taking or hitting the quote. The ME 14 application leverages a centralized logging mechanism for capturing warning and error conditions with real-time application activity and performance monitoring accomplished via a customer monitoring application. The ME 14 communicates two ways, either via multicast messaging or by shared memory, such as the IPC 18 for quotes and the SM 20 for market information from the MDR 22.

The MEI 16 and the ME 14 cooperate to support processing of quotes in the following manner.

In a typical scenario for quotes, the MEI 16 receives a Quote Block from a market maker. A Quote Block contains up to 50 single sided quotes. The MEI 16 validates the quote block and transforms it into an internal format as a single unit to send along to the matching engine (ME) 14 by writing the quote block to a dedicated shared memory area, i.e., bucket, for Inter-Process Communication (IPC) 18.

The ME 14 handles processing of the quotes in accordance with the flowchart of FIG. 8.

The ME 14 performs a round robin read of the buckets of the IPC 18, and then checks the multicast stream port for multicast communications, asynchronously reading the Shared Memory IPC 18 in round robin fashion. The ME spins at 100% cpu speed checking the Shared Memory IPC 18 for new quote blocks to process.

At step S1, the matching engine (ME) 14 begins the reading of the IPC 18 by selecting the first bucket of the IPC 18 and at step S3 reads the selected bucket of the IPC 18. If, at step S5, it is determined that no quote is found in the currently selected bucket, the flow proceeds to step S13, where it is determined if the current bucket is the last bucket in the IPC 18. If it is the last bucket, the flow proceeds to step S15 at which the ME 14 reads and processes MCAST messages from the MCAST port. Then the flow loops back to step S1 to select the first bucket again to start the process over again.

If, on the other hand, it is determined at step S5 that a quote is present in the current bucket, the flow proceeds to step S7, at which the ME 14 processes the quotes in the block serially. Each quote is processed as a discrete unit, entered into the electronic book, checked against the internal market and the Away Market BBO (ABBO located in the Shared Memory based Market Data Store) for possible execution. At step S9, executions are processed as needed and then each quote is transmitted to the High Bandwidth Bus (HBB) 25 using the multicast protocol and transmitted to a firm dedicated bucket in the Shared Memory IPC 18.

The ME 14 processes the quotes in a given quote block as one atomic unit, meaning no other transactions are initiated other than those derived from each quote in the block. At step S11, upon completion of processing a given Quote Block, the ME 14 writes a Quote Block ACK to a firm dedicated bucket of the Shared Memory IPC 18. After step S11, at step S13, it is determined if the last bucket has been processed. The case in which it is the last buck has been discussed above. If it is not the last bucket, then the flow proceeds to step S17, at which the next bucket is select, and the flow proceeds back to step S3, to read the shared memory of the currently selected bucket.

During the course of the ME 14's flow depicted in the flowchart, The MEI's 16 asynchronously read their respective firm dedicated Shared Memory IPC 18 checking for processed Quotes and Quote Block ACKs. Upon receiving a quote, the MEI 16 stores it in memory for later use. Upon receiving a Quote Block ACK, the MEI transmits the ACK to the originating Market Maker.

The matching engine 14 handles Multi-cast messages upon having finished reading and processing any quote blocks from the firm-associated buckets of IPC 18. That is, after finishing processing any block of quotes in each bucket, the matching engine checks its MCAST input port for messages that may have arrived from other applications in the trading system while it has been handling the blocks of quotes. Before returning to searching the IPC 18 for additional quote blocks, the matching engine 14 handles all requests that have been waiting on the input port.

A Market Data Reader application (MDR) 22 processes and loads ticker data into shared memory 20 for processing by the matching engine 14 and has a HOT-COLD failover design. The ME application 14 polls the shared memory 20 to receive updates to the ticker data as needed. The MDR application 22 leverages a centralized logging mechanism for capturing warning and error conditions and real-time application activity and performance monitoring is accomplished via a customer monitoring application.

High Speed Ticker Plant 500 provide from an Underlying Market Data interface (CTA app 504, UTP app 506) and an OP RA market data interface app 502. The Ticker Plant 500 applications provide underlying and option away market quotes and trades to support trading decision making and has a HOT-WARM failover design. The Ticket Plant application 500 leverages a centralized logging mechanism for capturing warning and error conditions with real-time application activity and performance monitoring accomplished via a customer monitoring application.

The FIX gateway 400 includes, in addition to the FOI 401 discussed below, an Away Market Order Router application (AMR) 404 and a Firm 58 Drop application (F58) 406.

The AMR application 404 functions as the FIX order parser, router and forwarder for orders routed to away options exchanges. The AMR application 404 supports routing orders to away options exchanges via independent order routing Broker Dealer(s) and has a HOT-WARM failover design. The AMR application 404 leverages a centralized logging mechanism for capturing warning and error conditions with real-time application activity and performance monitoring accomplished via a customer monitoring application. The F58 application 406 drops trade data to Firm 58 for billing purposes and has a HOT-HOT failover design. The F58 application 406 leverages a centralized logging mechanism for capturing warning and error conditions with real-time application activity and performance monitoring accomplished via a customer monitoring application.

The FIX Order Interface application (FOI) 401 in the FIX Gateway 400 supports order provider access to the FIX Order Entry Interface and has a HOT-WARM failover design. The FOI application 401 leverages a centralized logging mechanism for capturing warning and error conditions with real-time application activity and performance monitoring accomplished via a customer monitoring application. The FIX Gateway 400 provides a single entry point to the market and handles order routing to the MEs 14. Preferably, each FOI 401 application is dedicated to a particular connection to a firm, i.e., order flow provider.

An Order Logger application (ORL) 52 processes all order adds and updates to maintain and log the current order book state for the purposes of matching engine failure recovery and has a WARM-WARM failover design. The ORL application 52 leverages a centralized logging mechanism for capturing warning and error conditions with realtime application activity and performance monitoring accomplished via a customer monitoring application.

A Clearing Trade Drop 900 includes clearing trade drop applications (CTD) 901. The CTD applications 901 provide a Proprietary Clearing Trade Drop (i.e., interface) to Subscribers based on pre-configured entitlements, and have a HOT-HOT failover design. The CTD applications 901 leverage a centralized logging mechanism for capturing warning and error conditions with real-time application activity and performance monitoring accomplished via a customer monitoring application. Preferably, an exclusively dedicated CTD application 901 is provided per client.

A Stats Collector application (STC) 34 collects, collates and publishes statistics received by Trading Systems Apps for various Monitoring GUIs from the MCAST Stats Collection Bus 35 and has a HOT-HOT failover design. The STC 34 application leverages a centralized logging mechanism for capturing warning and error conditions.

A trading operations command (TOC) application 50 is an interface between the Business Systems Help Desk app and the Trading System and has a HOT-WARM failover design. The TOC application leverages a centralized logging mechanism for capturing warning and error conditions.

Referring to FIGS. 3-8, the matching engine (ME) 14 is a core functional business component of the electronic trading system. An electronic trading platform according to an example embodiment may comprise a plurality of matching engines 14 (e.g., twenty four) to distribute processing load; however example embodiments are not limited thereto and an electronic trading platform may comprise more or less than twenty four Trade matching engines. The MEI applications 16 and matching engine 14 application for each particular cloud reside on the same physical server to minimize network hops between the client and the matching engine. In contrast, the FOI applications 401 may reside on a separate physical server, e.g., the FIX Gateway 400, from the MEs 14 and send data/orders to a particular ME 14 via a command port without utilizing the shared memory IPC 18. As discussed above, the MEI applications 16 and the ME applications 14 for a particular cloud utilize a Shared Memory IPC 18 to speed communication therebetween.

Densely packed bulk quotes accessible by the ME 14 minimize I/O to increase speed. The MEI 16 atomically passes complete bulk quote blocks to the matching engine 14 for processing to minimize I/O overhead. The MEI 16 may receive quotes from Quoting Firms via TCP protocol messages. As discussed above, the MEI 16 does not use interrupts to notify the ME 14 that new or updated quotes/data have arrived. The MEI 16 instead writes the new or updated quotes/data to the shared memory IPC 18, and the ME 14 continuously polls the shared memory IPC 18. Thus, the MEI 16 and the ME 14 utilize shared memory IPC 18 to speed communication, and to allow the ME 14 to complete processing of the entire bulk quote fully before again searching the IPC 18 for more quotes. All other inputs to the ME 14 are by the ME 14's MCAST port, which is used by the ME 14 to receive MCAST messaging from Edge applications. Thus, for example, orders from the FIX Gateway are received by the ME 14 via MCAST messages at its MCAST port.

After the ME 14 reads a new quote from the shared memory IPC 18, the ME 14 determines if the quote has a matching contraside interest, performs allocation of any matching interests and transmits raw data about the quote and any match on the HBB 25. Analytics, however, are not performed on the raw data by the ME 14. All trading applications on the electronic trading platform may be developed. e.g., in C++, using only the fastest internal data structures. As shown in FIG. 3 dual matching engine servers 12a and 12b for each matching engine 14 and its respective MEI applications 16 may comprise Multi-core server technology to retain high throughput and low latency with multiple resources. As shown in the figures, MEI 16 and ME 14 applications reside in the same server minimizing network hops between the client and the ME 14.

All applications of the electronic trading platform may be pinned to CPUs, and applications share executing in poll mode to lower latency. The MEI 16 may comprise 10 Gbit Accelerated Ethernet Network Interface Cards with kernel by-pass Network Stack and Advanced High-Speed 10 Gbit Ethernet Switching Technology.

The ME 14 is configured to create internal books that keep the bid quotes on one side and offer quotes on another side for each series. In addition, the ME 14 is configured to keep track of the best bid and the best offer for each series. Pre-allocation of memory makes the ME 14 perform these functions in a very fast manner.

The ME 14 supports maintenance of a product cache for underlying and option series, and has the functionality to look up if a series is valid, and support new spin files for products.

The ME 14 provides support for what products the Market Makers are responsible for, for example, whether the Market Maker is the lead Market Maker.

With regard to Quotes, the ME 14 preferably is configured to perform the following functions:
Accept Bulk Quote
Process Bulk Quote
Send Acknowledgement back
Send all individual items back in acknowledgment
Add Quotes to a cache within the ME
Send Quote record updates
Replace old quotes with new quotes

With regard to Orders, the ME 14 preferably is configured to perform the following functions:
Accept New Order
Accept Cancel Order
Accept Replace Order
Add order to the book.
Publish acknowledgement back

Order Types supported by the ME 14 preferably include Market orders and Limit orders.

With regard to eQuotes, the ME 14 preferably is configured to perform the following functions:
Accept New eQuote message
Accept Cancel eQuote message
Accept Replace eQuote message
Add eQuote to the book.
Send acknowledgment back to MEI.
Order Types: Limit

With regard to Trades, the ME 14 preferably is configured to perform the following functions:
Cross Quote, eQuote, and Order
Create basic trade record.

With regard to Allocations, the ME 14 preferably is configured to perform Price Time and Basic Pro-Rata allocations.

The ME 14 preferably supports the following Cleanup functionality:
Change all cache updates to record updates
Add Engine sequence number to all outbound messages
Add srcAppld for any record update
Update all sizes related to all liquidity sources.
CacheUpdate to RecordUpdate
Perform Cleanup to remove old logic for Product and Equity.

With regard to Statistics, the ME 14 preferably is configured to create a Histogram of time to add quotes to the book.

Each of the Discrete Trade Matching Environments (clouds) are logically segmented Software Topologies with no Software Level Interdependence; however, Configuration Management and Operational Command, Control and Monitoring are Trade Matching Environment aware. A speed of scaling of the electronic trading platform is solely limited to the timeliness of Hardware Infrastructure Implementation, and the Hardware implementation is facilitated through utilization of the container approach discussed above. The electronic trading platform enables Load Balancing down to a single underlying if necessary or desired.

The MEI 16 provides Bulk Quote Support, eQuote Support, support for single sided quotes, an Atomic Automated Risk Monitor, Line Disconnect Protection (Atomic protection on an MPID basis), Mass Quote Cancels including an Atomic Underlying wildcard purge, an Atomic MPID wildcard purge and Quote Protection Reset to control re-entry into the market, Series Update messages, Dynamic Automated Risk Monitor setting control and Extensive Notifications including notifications for System State, Trading Status, Quote Width Relief, ARM Protection Setting, Quote Protection, Liquidity Seeking Event, Quote Cancel and Execution Notifications.

As described above, the MEI 16 receives quotes from Quoting Firms and stores the quotes in the IPC 18. The Quoting Firms direct the quotes to the MEI applications 16 of a particular cloud based on the underlying symbol for the quote. For example, in the quoting interface for the MEI applications 16, the Quoting Firms map the quote to a specific IP. In contrast, the FOI applications described in more detail below, automatically route quotes to the appropriate cloud.

The MEI 16 provides Throughput of more than 24 Million Quotes per Second (i.e., more than 1,000,000 transactions/second/Match Engine) for twenty four Match Engines. The MEI 16 provides latency of 21 microseconds Average Client Round Trip Time (RTT) for a single quote (no load), and 71 microseconds Average Client Round Trip Time (RTT) for a 50 quote block (no load) and Determinism having a Standard Deviation of 1.8 microseconds (no load).

The FOI 401, for FIX orders, provides for New Order—Single, Order Cancel and Cancel/Replace, Mass Order Cancels by MPID or MPID/Underlying Pair and by Connection (Session), Execution Report, Order Status, exchange Order Monitor protection including Market Order Price Protection, Limit Order Price Protection and Order Size Protections and the FIX Order Gateway 400, which provides a single entry point to the exchange market and handles order routing to matching engines 14 of the multi-cloud trading system.

The FOI 401 provides throughput of 7,700 transactions/second/FOI instance (no load), Latency of 130 microseconds Average Client Round Trip Time (RTT) for an unexecuted IOC order and Determinism having a Standard Deviation of 7.6 microseconds (no load).

The plurality of matching engines 14 (over the multiple clouds) distribute processing load received from the FOI 401. The FOI 401 may comprise 10 Gbit Accelerated Ethernet Network Interface Cards with kernel by-pass Network Stack and Advanced High-Speed 10 Gbit Ethernet Switching Technology.

To achieve scalability, the FOI 401 may comprise Discrete FIX Gateway servers which independently provide the FIX Order Interface service, and Configuration Management and Operational Command, Control and Monitoring may seamlessly manage the FIX Gateway servers. A Speed of Scaling is solely limited to the timeliness of Hardware Infrastructure Implementation. As discussed above, a Jump Server 700 provides symbol info and parameters from external exchanges or sources to each cloud/ME.

Terms of Equity Rights Program

The following are details of the terms under which participants will take part in the equity rights program in certain embodiments of the disclosed invention. The dollar and share amounts given below are understood merely to be examples for use in explaining the invention. In practice, the dollar and share amounts in an equity rights program will be determined by the particular characteristics of the exchange in which equity is being taken as well as other business considerations.

Each Participant will have the option to participate in any combination of: (a) an offering of up to 10 A-Units, (b) an offering of up to 10 B-Units, and (c) the C Warrant Rebate Program. An example of a description of the terms and conditions of each offering is set forth below for certain embodiments. Participants will have the opportunity to acquire A-Units and B-Units separately or in combination with one another. All members of the Exchange will be eligible to participate in the C Warrant Rebate Program regardless of whether such members acquires A or B Units.

Each A-Unit consists of: (i) the number of shares (the “Shares”) of common stock of the Company, par value $0.001 per share (“Common Stock”) that will result in the holder owning 0.2250% of the Common Stock as of a specific date, e.g., Jun. 30, 2013; and (ii) common stock purchase warrants (the “A-Warrants”) to purchase such number of shares of Common Stock which, combined with the Shares, equals 2.0% of the outstanding Common Stock of the Company, on a fully diluted basis, as of Jun. 30, 2013 after taking into account the total number of A and B Units issued at closing.

The Company may offer to the Participant Group a total of 10 A-Units. Assuming the issuance of all 10 A-Units, the Participants purchasing such A-Units will own 2.250% of the Common Stock calculated as of Jun. 30, 2013 (the “Participant Group Shares”) and A-Warrants to purchase such number of shares of Common Stock which, combined with the Participant Group Shares, equals 20% of the outstanding Common Stock of the Company, on a fully diluted basis, as of Jun. 30, 2013 after taking into account the total number of Units issued at closing. The purchase price per Share shall be $5.00. Assuming the sale of 10 A-Units, the purchase price and number of shares issuable for 1, 2, 3 and 10-A-Unit purchases is as follows:

One A-Unit: $519,010[103,802 shares]

Two A-Units: $1,038,020[207,604 shares]

Three A-Units: $1,557,030[311,406 shares]

10 A-Units: $5,190,100[1,038,020 shares]

In certain embodiments, in the event that less than 10 A-Units are sold, the purchase price and the number of shares and warrants issuable at closing will be slightly less to reflect the capitalization of the Company as of Jun. 30, 2013 after taking into account the actual number of A-Units sold.

The A-Warrants held by each Participant purchasing A-Units will vest in six tranches as follows:

(a) 10% of the A-Warrants (the “Initial Tranche”) shall vest upon the Closing Date in consideration of the Participant's purchase of Common Stock. The Participant does not need to satisfy any performance criteria in order to vest in the Initial Tranche of the A-Warrants.

(b) 8.1% of the A-Warrants shall vest on Nov. 30, 2013, provided such Participant has satisfied the performance criteria outlined on “Schedule A” (i.e., the “Performance Criteria”), presented below, during the two-month period commencing Sep. 1, 2013 through Oct. 31, 2013.

(c) 11.7% of the A-Warrants shall vest on Feb. 28, 2014 provided such Participant has satisfied the Performance Criteria during the three-month period commencing Nov. 1, 2013 through Jan. 31, 2014.

(d) 19.8% of the A-Warrants shall vest on Jul. 31, 2015 provided such Participant has satisfied the Performance Criteria during the five-month period commencing Feb. 1, 2014 through Jun. 30, 2014.

(e) 23.4% of the A-Warrants shall vest on Jan. 31, 2015 provided such Participant has satisfied the Performance Criteria during the six-month period commencing Jul. 1, 2014 through Dec. 31, 2014.

(f) 27% of the A-Warrants shall vest on Aug. 31, 2015 provided such Participant has satisfied the Performance Criteria during the seven-month period commencing Jan. 1, 2015 through Jul. 31, 2015.

Each B-Unit consists of common stock purchase warrants (the “B-Warrants”) to purchase such number of shares of Common Stock which equals 1.5% of the outstanding Common Stock of the Company, on a fully diluted basis, as of Jun. 30, 2013 after taking into account the total number of Units issued at closing. In order to receive B-Warrants, a Participant participating in the B-Unit Offering must prepay certain Exchange fees for the 23-month period commencing Sep. 1, 2013 and ending Jul. 31, 2015 (the “Prepaid Fee Period”).

One B-Unit: In the event that a Participant elects to prepay certain Exchange Fees for the Prepaid Fee Period in the amount of $500,000, such Member shall receive one B-Unit.

Two B-Units: In the event that a Participant elects to prepay certain Exchange Fees for the Prepaid Fee Period in the amount of $1,000,000, such Member shall receive two B-Units.

Three B-Units: In the event that a Participant elects to prepay certain Exchange Fees for the Prepaid Fee Period in the amount of $1,500,000, such Member shall receive three B-Units.

The Company is offering to the Participant Group a total of 10 B-Units. Assuming the issuance of all 10 B-Units, the Participants purchasing such B-Units will own B-Warrants to purchase such number of shares of Common Stock which equals 15% of the outstanding Common Stock of the Company, on a fully diluted basis, as of Jun. 30, 2013 after taking into account the total number of Units issued at closing.

The B-Warrants held by each Participant purchasing B-Units will vest in five tranches as follows:

(a) 9% of the B-Warrants shall vest on Nov. 30, 2013, provided such Participant has satisfied the Performance Criteria during the two-month period commencing Sep. 1, 2013 through Oct. 31, 2013.

(b) 13% of the B-Warrants shall vest on Feb. 28, 2014 provided such Participant has satisfied the Performance Criteria during the three-month period commencing Nov. 1, 2013 through Jan. 31, 2014.

(c) 22% of the B-Warrants shall vest on Jul. 31, 2014 provided such Participant has satisfied the Performance Criteria during the five-month period commencing Feb. 1, 2014 through Jun. 30, 2014.

(d) 26% of the B-Warrants shall vest on Jan. 31, 2015 provided such Participant has satisfied the Performance Criteria during the six-month period commencing Jul. 1, 2014 through Dec. 31, 2014.

(e) 30% of the B-Warrants shall vest on Aug. 31, 2015 provided such Participant has satisfied the Performance Criteria during the seven-month period commencing Jan. 1, 2015 through Jul. 31, 2015.

To be eligible to participate in the C-Warrant Rebate Program, members of the Exchange will be required to prepay certain Exchange transaction fees at any of the three periods as set forth below which fees may be utilized during certain measurement periods until Jul. 31, 2015. In the event that there remain any unused prepaid fees at Jul. 31, 2015, they will be forfeited to the Exchange.

Prepayment of the following transaction fees will give members of the Exchange (“C Members”) the right to participate in the C-Warrant Rebate Program and earn warrants (the “C-Warrants”) during the following periods, with each Tranche of C-Warrants referenced below as shown on “Schedule A,” presented below.

$500,000 payable on Sep. 1, 2013 to participate in Tranches 1, 2 and 3;

$500,000 payable on Jul. 1, 2014 to participate in Tranche 4; and

$500,000 payable on Jan. 1, 2015 to participate in Tranche 5.

C Members not otherwise holding A or B Units may elect to prepay transaction fees for any individual fee prepayment period set forth above by their respective due dates, provided that such C Members' ability to earn C-Warrants will be limited to the periods for which such C Members have prepaid fees. C Members can participate in all tranches or just those tranches that they have elected to prepay transaction fees. Over-performing holders of A and B Units (the “Over-Performing A and B Unit Holders”) will not be required to prepay additional Exchange fees as set forth above and such Over-Performing A and B Unit Holders shall be automatically deemed to be eligible for the C-Warrant Rebate Program, as described below.

Over-Performing A and B Unit Holders can also participate in the C-Warrant Rebate Program in the event they vest in 100% of the A or B Warrants acquired during any applicable vesting period and have over performed in excess of 100% of the Performance Criteria applicable to such Units. The participation of the Over-Performing A and B Unit Holders will be limited to such percentage of performance in excess of 100% of the Performance Criteria applicable to the A or B Unit offering, as the case may be.

The C-Warrant Rebate Program gives the members of the Exchange the right to acquire up to an aggregate of 11°/o of the company equity through the exercise of C-Warrants to purchase Common Stock of the Company, calculated as follows. The number of C-Warrants is equal to an aggregate of 11°/o of the outstanding Common Stock of the Company as of Jun. 30, 2013 on a fully diluted basis taking into account the total number of A and B Units and C-Warrants as of the Closing Date.

The A-Warrants, B-Warrants and C-Warrants (together, the “Warrants”) shall have an exercise price per share of Common Stock in an amount calculated as of Jun. 30, 2013 on a fully diluted basis taking into account the total number of Units issued as of the Closing Date such that the blended price for all Units shall be based on a $75 million post-Closing valuation of the Company assuming the vesting of all Warrants. The exercise price of A-Warrants will also reflect the receipt of the initial consideration paid for the Participant Group Shares by Participants acquiring A-Units; accordingly, the exercise price of A-Warrants will be less than the exercise price of B-Warrants and C-Warrants.

In the event a Participant holding A-Warrants or B-Warrants meets less than 100% of its Performance Criteria during any one of the five measurement periods applicable to the Warrants as set forth on “Schedule A,” presented below, (i.e., the “Measurement Periods” and each, a “Measurement Period”), but at least 70% of its Performance Criteria during such applicable Measurement Period (the “Minimum Performance Criteria”), the A-Warrants or B-Warrants related to that Measurement Period will vest pro-rata. C-Warrants will not be eligible for pro-rata vesting.

Notwithstanding any vesting requirements applicable to the A-Warrants and B-Warrants, in the event that a Participant holding A-Warrants or B-Warrants satisfies less than 100% of the Performance Criteria during any one Measurement Period (other than Measurement Period 5) (each, a “Prior Period”), such Participant may still vest in the A-Warrant Shares or B-Warrant Shares subject to such Prior Period (as the case may be) by applying a portion of such Participant's performance during the Measurement Period immediately following the Prior Period which would result in the Participant's performance during the Prior Period to total not less than the Minimum Performance Criteria. A-Warrants and B-Warrants will vest on a basis such that the Company will allocate volume provided by a Participant to ensure that the maximum number of Warrants vest. C-Warrants will not be eligible for catch-up vesting as described herein

By way of example and in accordance with the volume and exchange listing assumptions set forth on “Schedule A,” presented below, if a one-Unit Participant (i) meets 60% of its Performance Criteria applicable to Measurement Period 1 (36,552 sides per day), then (ii) meets 125% of its Performance Criteria in Measurement Period 2 (113,377 sides per day), an amount equal to 40% of the Performance Criteria previously unsatisfied during Measurement Period 1 (24,367 sides per day) will be applied toward Measurement Period 1, resulting in such Participant receiving credit for 100% of its Performance Criteria for Measurement Period 1 and 100% of its Performance Criteria for Measurement Period 2, and all A-Warrants or B-Warrants (as applicable) subject to Measurement Periods 1 and 2 will vest.

Unvested A-Warrants or B-Warrants held by a Participant who fails to vest in any portion of such A-Warrants or B-Warrants during a given Measurement Period due to the Participant not meeting its own individual volume requirements (a “Non-Performing Participant”) will be reallocated from such Participant to each Participant holding A-Warrants or B-Warrants who has exceeded 100% of its individual volume requirements for such Measurement Period, if applicable. Such reallocation of Warrants shall be pro-rata based on performance and shall be deemed to occur as of the vesting date of the A-Warrants or B-Warrants subject to reallocation, as the case may be (i.e., after taking into account any catch-up performance by such Participant). The exercise price of the reallocated Warrants shall be the same as the exercise price of the unvested Warrants. The total equity to be held by any one Participant will be subject to an overall cap of 19.9%. Holders of C-Warrants who are not also holders of A-Warrants or B-Warrants will not be eligible to receive unvested A-Warrants or B-Warrants from any Non-Performing Participant, and the C-Warrants will not be reassigned to Participants holding A-Warrants or B-Warrants in the event of a Non-Performing Participant holding C-Warrants.

Notwithstanding the foregoing, a Participant whose performance in a given Measurement Period exceeds 100% of its Performance Criteria will not be eligible to receive an allocation of unvested Warrants from a Non-Performing Participant if such Participant's over-performance is applied to a Prior Period in order to vest in Warrants which did not vest with such Participant in the Prior Period.

Performance Criteria for the Warrants (“Schedule A”)

1. Unit Holders OCC/Exchange Volume and Warrant Vesting.

A Participant who is a market maker on the Exchange (a “MM”) or an Electronic Exchange Member on the Exchange (a “EEM”) will receive one credit for each side of a transaction executed on the Exchange by such Participant or its affiliates. The “Target Volume” for a Participant on a per Unit basis for each month during the relevant measurement period shall be the number of option contracts in an amount not less than the following percentages of the OCC average daily options contracts volume as reported by the OCC for the option contracts that are trading on the Exchange (“OCC/Exchange Volume”), less the Functionality Discount (defined below), multiplied by 2, as shown below.

| | | Percentage of | Percent of | Percent of |
|---|---|---|---|---|
| | | OCC/ | A-Warrant | B-Warrant |
| | | Vol. | Shares Subject | Shares Subject |
| Tranche | Measurement Period | Per 1 Unit | to Vesting | to Vesting |
| 1 | Sep. 1, 2013-Oct. | .225% | 8.1% | 9.0% |
| | 31, 2013 | | | |
| 2 | Nov. 1, 2013-Jan. | .335% | 11.7% | 13.0% |
| | 31, 2014 | | | |
| 3 | Feb. 1, 2014-Jun. 30, | .445% | 19.8% | 22.0% |
| | 2014 | | | |
| 4 | Jul. 1, 2014-Dec. 31, | .556% | 23.4% | 26.0% |
| | 2014 | | | |
| 5 | Jan. 1, 2015-Jul. 31, 2015 | .667% | 27.0% | 30.0% |
| | Total | | 90.0% | 100.0% |

The following tables summarize the Performance Criteria for one, two and three Unit transactions based on the following assumptions: Equity and ETF ADV is 15,000,000 contracts; exchange listings account for 95% of all ADV; and the Functionality Discount. Performance Criteria shown for two and three Units represent the aggregate criteria underlying such Units. Warrants will vest on a basis such that the Company will allocate volume provided by a Participant to ensure that the maximum number of Warrants vest.

| | | | | | |
|---|---|---|---|---|---|
| Units | Tranche 1 | Tranche 2 | Tranche 3 | Tranche 4 | Tranche 5 |

Contract Sides as a Percentage of 2x ADV

| | | | | | |
|---|---|---|---|---|---|
| 1 | 0.225% | 0.335% | 0.445% | 0.556% | 0.667% |
| 2 | 0.450% | 0.670% | 0.890% | 1.112% | 1.334% |
| 3 | 0.675% | 1.005% | 1.335% | 1.668% | 2.000% |

Contract Sides per day, 100% Earning

| | | | | | |
|---|---|---|---|---|---|
| 1 | 60,919 | 90,701 | 120,484 | 158,460 | 190,095 |
| 2 | 121,838 | 181,403 | 240,968 | 316,920 | 380,190 |
| 3 | 182,756 | 272,104 | 361,451 | 475,380 | 570,000 |

Contract Sides per day, 70% Earning

| | | | | | |
|---|---|---|---|---|---|
| 1 | 42,643 | 63,491 | 84,339 | 110,922 | 133,067 |
| 2 | 85,287 | 126,982 | 168,678 | 221,844 | 266,133 |
| 3 | 127,929 | 190,473 | 253,016 | 332,766 | 399,000 |

2. C Warrant Rebate Program OCC/Exchange Volume and Warrant Vesting.

A Participant who is an MM or an EEM will receive one credit for each side of a transaction executed on the Exchange by such Participant or its affiliates. The “Target Volume” for a Participant participating in the C Warrant Rebate Program for each month during the relevant measurement period shall be the number of option contracts in an amount not less than the following percentages of the OCC/Exchange Volume, less the Functionality Discount (defined below), multiplied by 2, as shown below. Trades counting towards a C Member's Target Volume under the C Warrant Rebate Program may not be used by such member for credit in the A Unit or B Unit transactions.

| | | | | | (D) |
|---|---|---|---|---|---|
| | | | | (C) | Aggregate |
| | | | (B) | Aggregate | Equity |
| | | | Minimum | C-Warrant | Percentage |
| | | (A) | Threshold | Earn-out | Earn-Out by C |
| | | Targeted | Percentage of | Percentage | Members in |
| | | Percentage of | OCC/Exch Vol. | of Each Period | the Aggregate |
| | | OCC/Exch Vol. | Required to be | if Percentage | Assuming |
| | | for All C | Met by Each C | Target of | Target of |
| | Measurement | Members in | Member | Column A is | Column A is |
| Tranche | Period | the Aggregate | Individually | Met* | Met |
| 1 | Sep. 1, | 1.6875% | .562% | 9.00% | 0.99% |
| | 2013-Oct. | | | | |
| | 31, 2013 | | | | |
| 2 | Nov. 1, | 2.5110% | .837% | 13.00% | 1.43% |
| | 2013-Jan. | | | | |
| | 31, 2014 | | | | |
| 3 | Feb. 1, | 3.3300% | 1.111% | 22.00% | 2.42% |
| | 2014-Jun. | | | | |
| | 30, 2014 | | | | |
| 4 | Jul. 1, 2014-Dec. | 4.1670% | 1.389% | 26.00% | 2.86% |
| | 31, 2014 | | | | |
| 5 | Jan. 1, 2015-Jul. | 5.0000% | 1.667% | 30.00% | 3.30% |
| | 31, 2015 | | | | |
| | Total | | | 100.00% | 11.00% |

*Total percentage of the C-Warrants which will be set aside for the applicable period.

A C Member who individually meets the minimum threshold percentage of OCC/Exchange Volume during the applicable period as set forth in Column B and has prepaid fees will earn a portion of the percentage of C-Warrants set forth in Column C on a pro rata basis with other C Members who meet their minimum threshold requirements of Column B as well as Over-Performing A and B Unit Holders, corresponding with the Equity percentage set forth in Column D. If the total targeted aggregate percentage of OCC/Exchange Volume for all C Members in the aggregate set forth in Col. A is met by one or more C Members, the entire percentage of the aggregate C-Warrants Earn Out Percentage for the applicable period will be available for distribution to the C Members on a pro rata basis.

In the event that, during a given Measurement Period, the aggregate target set forth in Column A is not met but one or more C Members individually meet their respective minimum threshold percentage of OCC/Exchange Volume during such Measurement Period, such C Member(s) will earn a percentage of the C-Warrants based on their pro rata performance of the overall OCC/Exchange Volume total contributed by the C Members as a group as compared to the aggregate C-Warrant Earn-Out Percentage attributable to the period.

### Example 1

### Col. A Target is Met

If the Column A target during Measurement Period 1 of 1.6875% is met by the C Members, all C Members meeting not less than 0.562% OCC/Exchange Volume during Measurement Period 1 will share in 9.00% of C Warrants on a pro rata basis, representing 0.99% of Equity as a group.

### Example 2

### Col. A Target is Not Met

If OCC/Exchange Volume of the C Members as a group during Measurement Period 1 is 1.5%, individual C Members satisfying their individual performance criteria will earn C-Warrants based on their pro rata percentage of total OCC/Exchange Volume of the C Members as a group. Accordingly, if a C Member's OCC/Exchange Volume during Measurement Period 1 is 0.562% based on a total of 1.5% being met by the C Members as a group during Measurement Period 1, such C Member will have earned 37.47% of the C-Warrants subject to Tranche 1 (3.3723%), representing 0.3710% of Equity.

3. Functionality Discount and Exclusions from Target Volume Calculation.

“Functionality Discount” means a discount of 5% of defined ADV taken through Mar. 31, 2014 for certain functionality not yet established on the Exchange. In the event that such functionality is not established by Mar. 31, 2014, the Functionality Discount shall be increased to 10% of defined ADV. In the event that such functionality is not established by Jul. 1, 2014, the Functionality Discount shall be increased to 15% of defined ADV. The Functionality Discount shall no longer apply effective as of the date that such functionality is established on the Exchange.

Priority Customer-to-Priority Customer transactions where no fees are paid to the Options Exchange, other special strategies (such as short interest and dividend), and contracts as to which a Participant acts solely as clearing agent will not be counted in the number of option contracts executed on the Options Exchange by any Participant. Special strategies (such as short interest and dividend) will not be counted by the exchange in the OCC/Exch Vol to the extent it is possible to identify such transactions.

Although example embodiments have been shown and described in this specification and figures, it would be appreciated by those skilled in the art that changes may be made to the illustrated and/or described example embodiments without departing from their principles and spirit.

1. A method of monitoring an equity rights program in which units representing the right to acquire equity in an exchange are issued to participating members based upon achievement of defined volume thresholds on the exchange over specified periods, the method being implemented using a server having a processor, memory, and a storage medium, the method comprising:
storing exchange trade data in a trading data storage in a time series format, the trading data storage being implemented in the storage medium of the server, the exchange trade data being received, via a network interface of the server, from a trade data output of the exchange;
retrieving the stored exchange trade data from the trading data storage and transforming the exchange trade data into a star schema data format;
storing the transformed exchange trade data in a reporting data storage;
retrieving, from a clearing entity, industry options trade data and industry options exercise data and transforming the retrieved industry options trade data and the industry options exercise data into a star schema data format;
storing the transformed industry options trade data and the transformed industry options exercise data in the reporting data storage; and
processing the stored transformed exchange trade data, the stored transformed industry options trade data, the stored transformed industry options exercise data, and reference data, the reference data comprising the defined volume thresholds on the exchange over one or more time periods of the specified periods, to produce performance data for each of the participating members, the performance data comprising a measure of the achievement of each of the participating members relative to their corresponding defined volume thresholds on the exchange over the one or more time periods.

2. The method of claim 1, further comprising determining a number of the units representing the right to acquire equity in the exchange for which each said participating member is eligible based on the performance data for each said participating member.

3. The method of claim 1, further comprising:
processing the stored transformed industry options trade data and the stored transformed industry options exercise data to identify dividend trades; and
determining a volume of dividend trades from the identified dividend trades and storing the determined volume of dividend trades in the reporting data storage.

4. The method of claim 3, wherein the determining of the volume of dividend trades comprises:
identifying all call option strikes that have non-zero exercises for the given business date (CallExcerciseVolume);
determining, using the stored transformed industry options trade data and the stored transformed industry options exercise data, a total volume of all trades with a size greater than a set quantity threshold for the identified call option strikes (LargeIndustryTradeVolume);
determining a total industry trade volume for each of the identified call option strikes (IndustryTradeVolume);
determining, using industry open interest data, open interests for a current business date (CurrentOpenInterest) and open interests for a previous business date (PreviousOpenInterest) for each of the identified call option strikes; and
determining, for each security symbol of the identified call option strikes, a total call option exercise volume (totalCallExerciseVolume), total industry trades volume (totalIndustryTradesVolume), total large industry trades volume (totalLargeIndustryTradesVolume), total previous open interests (totalPreviousOpenInterests), total current open interests (totalCurrentOpenInterests), total effective open interests differential (totalEffectiveOpenInterestsDelta), and total dividend play volume (totalDividendPlayVolume);
reporting total dividend play volume (totalDividendPlayVolume) if it is greater than a set quantity threshold of contracts for security symbols which have an ex-dividend date on a next business date and have a total call exercise volume (totalCallExerciseVolume) of more than a set quantity threshold.

5. The method of claim 3, wherein, for each participating member, the performance data comprises: exchange trading volume for each said participating member; industry trading volume for each said participating member for all option classes listed on the exchange; and dividend trading volume for each said participating member.

6. The method of claim 5, wherein, for each participating member, the performance data further comprises: realized performance for each said participating member; and realized performance relative to one or more defined volume thresholds on the exchange over specified periods for each said participating member, the realized performance being determined by a ratio, the ratio having a numerator which is the exchange trading volume for each said participating member and a denominator which is the industry trading volume for each said participating member minus the dividend trading volume for each said participating member.

7. The method of claim 6, further comprising determining a number of the units representing the right to acquire equity in the exchange for which each said participating member is eligible based on the realized performance relative to one or more defined volume thresholds on the exchange over specified periods for each said participating member.

8. A system for monitoring an equity rights program in which units representing the right to acquire equity in an exchange are issued to participating members based upon achievement of defined volume thresholds on the exchange over specified periods, the system including a server comprising:
a processor,
memory,
a storage medium, and
a network interface,
wherein the server is configured to:
store exchange trade data in a trading data storage in a time series format, the trading data storage being implemented in the storage medium of the server, the exchange trade data being received, via the network interface of the server, from a trade data output of the exchange;
retrieve the stored exchange trade data from the trading data storage and transform the exchange trade data into a star schema data format;
store the transformed exchange trade data in a reporting data storage;
retrieve, from a clearing entity, industry options trade data and industry options exercise data and transform the retrieved industry options trade data and the industry options exercise data into a star schema data format;
store the transformed industry options trade data and the transformed industry options exercise data in the reporting data storage; and
process the stored transformed exchange trade data, the stored transformed industry options trade data, the stored transformed industry options exercise data, and reference data, the reference data comprising the defined volume thresholds on the exchange over one or more time periods of the specified periods, to produce performance data for each of the participating members, the performance data comprising a measure of the achievement of each of the participating members relative to their corresponding defined volume thresholds on the exchange over the one or more time periods.

9. The system of claim 8, wherein the sever is further configured to determine a number of the units representing the right to acquire equity in the exchange for which each said participating member is eligible based on the performance data for each said participating member.

10. The system of claim 8, wherein the server is further configured to:
process the stored transformed industry options trade data and the stored transformed industry options exercise data to identify dividend trades; and
determine a volume of dividend trades from the identified dividend trades and store the determined volume of dividend trades in the reporting data storage.

11. The system of claim 10, wherein the server is configured to determine the volume of dividend trades by:
identifying all call option strikes that have non-zero exercises for the given business date (CallExcerciseVolume);
determining, using the stored transformed industry options trade data and the stored transformed industry options exercise data, a total volume of all trades with a size greater than a set quantity threshold for the identified call option strikes (LargeIndustryTradeVolume);
determining a total industry trade volume for each of the identified call option strikes (IndustryTradeVolume);
determining, using industry open interest data, open interests for a current business date (CurrentOpenInterest) and open interests for a previous business date (PreviousOpenInterest) for each of the identified call option strikes; and
determining, for each security symbol of the identified call option strikes, a total call option exercise volume (totalCallExerciseVolume), total industry trades volume (totalIndustryTradesVolume), total large industry trades volume (totalLargeIndustryTradesVolume), total previous open interests (totalPreviousOpenInterests), total current open interests (totalCurrentOpenInterests), total effective open interests differential (totalEffectiveOpenInterestsDelta), and total dividend play volume (totalDividendPlayVolume);
reporting total dividend play volume (totalDividendPlayVolume) if it is greater than a set quantity threshold of contracts for security symbols which have an ex-dividend date on a next business date and have a total call exercise volume (totalCallExerciseVolume) of more than a set quantity threshold.

12. The system of claim 10, wherein, for each participating member, the performance data comprises: exchange trading volume for each said participating member; industry trading volume for each said participating member for all option classes listed on the exchange; and dividend trading volume for each said participating member.

13. The system of claim 12, wherein, for each participating member, the performance data further comprises: realized performance for each said participating member; and realized performance relative to one or more defined volume thresholds on the exchange over specified periods for each said participating member, the realized performance being determined by a ratio, the ratio having a numerator which is the exchange trading volume for each said participating member and a denominator which is the industry trading volume for each said participating member minus the dividend trading volume for each said participating member.

14. The system of claim 13, further comprising determining a number of the units representing the right to acquire equity in the exchange for which each said participating member is eligible based on the realized performance relative to one or more defined volume thresholds on the exchange over specified periods for each said participating member.

15. A computer-readable medium storing instructions for causing a processor to perform a method for monitoring an equity rights program in which units representing the right to acquire equity in an exchange are issued to participating members based upon achievement of defined volume thresholds on the exchange over specified periods, the method being adapted to be implemented using a server having a processor, memory, and a storage medium, the method comprising:
storing exchange trade data in a trading data storage in a time series format, the trading data storage being implemented in the storage medium of the server, the exchange trade data being received, via a network interface of the server, from a trade data output of the exchange;
retrieving the stored exchange trade data from the trading data storage and transforming the exchange trade data into a star schema data format;
storing the transformed exchange trade data in a reporting data storage;
retrieving, from a clearing entity, industry options trade data and industry options exercise data and transforming the retrieved industry options trade data and the industry options exercise data into a star schema data format;
storing the transformed industry options trade data and the transformed industry options exercise data in the reporting data storage; and
processing the stored transformed exchange trade data, the stored transformed industry options trade data, the stored transformed industry options exercise data, and reference data, the reference data comprising the defined volume thresholds on the exchange over one or more time periods of the specified periods, to produce performance data for each of the participating members, the performance data comprising a measure of the achievement of each of the participating members relative to their corresponding defined volume thresholds on the exchange over the one or more time periods.
